(19) United States
(12) Patent Application Publication
(10) Pub. No.: US 2019/0190082 A1
(43) Pub. Date: Jun. 20, 2019

(54) BATTERY AND ELECTRONIC DEVICE

(71) Applicant: MURATA MANUFACTURING CO., LTD., Kyoto (JP)

(72) Inventors: Masahiro MOROOKA, Kyoto (JP); Kazuo SASAKI, Kyoto (JP); Yoshiichi HORIKOSHI, Kyoto (JP); Yusuke TANJI, Kyoto (JP); Kenta HONDA, Kyoto (JP)

(21) Appl. No.: 16/284,692

(22) Filed: Feb. 25, 2019

Related U.S. Application Data
(63) Continuation of application No. PCT/JP2017/023630, filed on Jun. 27, 2017.

(30) Foreign Application Priority Data
Aug. 26, 2016 (JP) 2016-165418
Oct. 17, 2016 (JP) 2016-203963

(51) Int. Cl. H01M 10/0585; H01M 2/02

(52) U.S. Cl. CPC H01M 10/0585; H01M 2/0287; H01M 2220/30; H01M 2/0285; H01M 2/0207; H01M 2/028

(57) ABSTRACT

A battery includes a multilayer structure including a plurality of multilayer members and an external packaging member configured to cover the multilayer structure. each of the multilayer members includes a positive electrode member provided with a positive electrode current collector and a positive electrode mix layer provided on a surface of the positive electrode current collector, a separator configured to contain an electrolyte, and a negative electrode member including a negative electrode current collector and a negative electrode mix layer provided on a surface of the negative electrode current collector; the positive electrode member, the separator and the negative electrode member are laminated together and the positive electrode mix layer and the negative electrode mix layer face each other; the multilayer members are stacked on each other in such a manner that current collectors having a same polarity face each other.

### CROSS REFERENCE TO RELATED APPLICATIONS

The present application is a continuation of PCT patent application no. PCT/JP2017/023630, filed on Jun. 27, 2017, which claims priority to Japanese patent application no. JP2016-165418 filed on Aug. 26, 2016 and JP2016-203963 filed on Oct. 17, 2016, the entire contents of which are being incorporated herein by reference.

### BACKGROUND

The present disclosure generally relates to a battery, more specifically a sheet-like secondary battery having flexibility. The present disclosure also relates to an electronic device provided with the battery.

The shape stability of a secondary battery is critical from the viewpoint of safety, and therefore a secondary battery has been designed to have hardness and inflexibility. However, with the recent development of information devices including wearable devices, a secondary battery having flexibility and bendability has been increasingly demanded. As the secondary battery for an information device such as a smartphone, a secondary battery composed of a film-like external packaging member having a high degree of flexibility in shaping and a flat multilayer structure enclosed in the external packaging member has been widely used. It has been keenly demanded to make a secondary battery having the above-mentioned configuration bendable so that the secondary battery can be applied to an information device such as a wearable device.

When a secondary battery is curled, there is caused a difference between the length Lᵢₙ of the inner surface of the curled secondary battery and the length Lₒᵤₜ of the outer surface of the curled secondary battery (wherein the difference is referred to a “difference in perimeter”, for convenience). As a result, a stress in the direction of compression is applied to the inner surface, while a stress in the direction of stretching is applied to the outer surface. The stresses increase with the decrease in the radius of curvature of the curl. Among the constituent members in the inside of a secondary battery, particularly a metallic member (e.g., a positive electrode current collector, a negative electrode current collector) can enter a plastically deformed area easily upon stretching, and the shape of the metallic member is not sometimes restored from an extended state. Therefore, there is caused the problem that, upon the curling of the secondary battery again, a part at which the plastic deformation occurs in the metallic material is blistered and remains as wrinkles in appearance. Furthermore, when the secondary battery is curled repeatedly, a stress is concentrated to the wrinkled part, and consequently the problem that the external packaging member is broken, the sealing layer is delaminated or the current collector is broken may occur.

### SUMMARY

In the conventional technology, the electrical storage device can be deformed due to the movement of the positive electrodes and the negative electrodes through the sliding on the surface of the separators, and the electrical storage device can have flexibility at least in the uniaxial direction as the result of the packaging of the electrical storage device in a flexible external packaging body composed of, for example, a laminate film. However, the distance between electrodes may be changed easily when the sheet-like electrical storage device is curled, and the sheet-like positive electrodes and the sheet-like negative electrodes that respectively face the sheet-like positive electrodes move relative to each other. Consequently, the electrode mixes or the current collectors may break through the separators, and therefore short circuit may occur, and the reliability or safety of the electrical storage device may be deteriorated.

Therefore, one object of the present disclosure is to provide a battery having flexibility and high safety and an electronic device provided with the battery.

According to an embodiment of the present disclosure, a battery is provided. The battery comprising a multilayer structure including a plurality of multilayer members and an external packaging member configured to cover the multilayer structure,

wherein:

each of the multilayer members includes
a positive electrode member including a positive electrode current collector and a positive electrode mix layer provided on a surface of the positive electrode current collector,
a separator configured to contain an electrolyte, and
a negative electrode member including a negative electrode current collector and a negative electrode mix layer provided on a surface of the negative electrode current collector;

the positive electrode member, the separator and the negative electrode member are laminated together, and the positive electrode mix layer and the negative electrode mix layer face each other;

the multilayer members are stacked on each other in such a manner that current collectors having a same polarity face each other; and

the external packaging member includes at least a resin layer having a Young's modulus of 3×10⁹ Pa or more, preferably 4×10⁹ Pa or more.

According to an embodiment of the present disclosure, a battery is provided. The battery comprises a multilayer member and an external packaging member configured to cover the multilayer member,

wherein:

the multilayer member includes
a positive electrode member including a positive electrode current collector and a positive electrode mix layer provided on a surface of the positive electrode current collector,
a separator configured to contain an electrolyte, and
a negative electrode member including a negative electrode current collector and a negative electrode mix layer provided on a surface of the negative electrode current collector;

the positive electrode member, the separator and the negative electrode member are laminated together;

the electrolyte has a gel-like or solid form; and

the external packaging member includes at least a resin layer having a Young's modulus of 3×10⁹ Pa or more, preferably 4×10⁹ Pa or more.

According to an embodiment of the present disclosure, a battery is provided. The battery comprises an electrode body having a laminated structure and an external packaging member,

wherein:

the external packaging member a metal layer including aluminum, a first resin layer provided on a first surface of the metal layer, and a second resin layer provided on a second surface of the metal layer;

the external packaging member is configured to accommodate the electrode body in such a manner that the first resin layer is located on an outer side; and

the first resin layer includes at least one of polyethylene terephthalate and polyethylene naphthalate, and the first resin layer has a thickness of more than 40 μm.

According to an embodiment of the present disclosure, an electrode body comprises
a positive electrode including a positive electrode current collector and a positive electrode active material layer provided on a surface of the positive electrode current collector,
a negative electrode including a negative electrode current collector and a negative electrode active material layer provided on a surface of the negative electrode current collector, and
a separator provided between the positive electrode and the negative electrode;
   and

wherein the positive electrode active material layer and the negative electrode active material layer face each other with the separator interposed therebetween.

According to an embodiment of the present disclosure, an electrode body comprises
two first electrodes each including a first current collector and a first active material layer provided on a surface of the first current collector,
a second electrode including a second current collector and second active material layers respectively provided on both surfaces of the second current collector, and wherein the second electrode is provided between the two first electrodes, and
separators each provided between each of the first electrodes and the second electrode; and

wherein each of the first active material layers faces the second active material layer with each of the separators interposed therebetween.

According to an embodiment of the present disclosure, an electronic device including the battery as described herein is provided.

In the battery according to the embodiments as described herein, in the multilayer member, a mix layer is formed on only one surface (also referred to as “first surface” for convenience) of a current collector, and the other surface (also referred to as “second surface” for convenience) of the current collector comes in contact with a second surface of a current collector in an adjacent multilayer member. Accordingly, when the battery is curled, the second surfaces of the current collectors that face each other move (slide) relative to each other. Consequently, the stress subjected to the multilayer structure as the result of the curling of the battery is substantially divided and reduced to a stress to be subjected to one layer of the multilayer structure. Furthermore, an external packaging member is provided with at least a resin layer having a Young's modulus of 3×10⁹ Pa or more, and therefore the occurrence of excessive deformation of the external packaging member can be prevented.

As a result, a battery having high safety and flexibility and having high resistance to bending can be provided. In a battery according to the second aspect of the present disclosure, an electrolyte has a gel-like or solid form, and therefore a positive electrode member and a negative electrode member are less likely to move relative to each other when the battery is curled. Furthermore, an external packaging member includes at least a resin layer having a Young's modulus of 3×10⁹ Pa or more, and therefore the occurrence of excessive deformation of the external packaging member can be prevented. In a battery according to the third aspect of the present disclosure, an external packaging member is provided with at least a resin layer having a thickens of more than 40 μm and containing at least one of polyethylene terephthalate and polyethylene naphthalate, and therefore the bending resistance of the battery against repeated curling can be improved. As a result, a battery having high safety and flexibility and having high resistance to bending can be provided.

The advantageous effects mentioned in the present description are for illustrative purpose only and are not limited to the above-mentioned effects, and other suitable properties relating to the present technology may be realized and as further described.

### BRIEF DESCRIPTION OF THE FIGURES

FIG. 1A is a schematic cross-sectional view of a multilayer structure constituting a battery according to an embodiment of the present technology.

FIG. 1B is a schematic cross-sectional view of a multilayer member constituting the battery according to an embodiment of the present technology.

FIG. 1C is a schematic cross-sectional view of the battery according to an embodiment of the present technology.

FIG. 1D is a schematic plan view of the battery according to an embodiment of the present technology.

FIG. 2 is an exploded perspective view of the battery according to an embodiment of the present technology.

FIG. 3A is a schematic plan view of a positive electrode member constituting the battery according to an embodiment of the present technology.

FIG. 3B is a schematic plan view of a positive electrode member constituting the battery according to an embodiment of the present technology.

FIG. 4A is a schematic plan view of a negative electrode member constituting the battery according to an embodiment of the present technology.

FIG. 4B is a schematic plan view of a negative electrode member constituting the battery according to an embodiment of the present technology.

FIG. 5A is a schematic plan view of a multilayer member according to an embodiment of the present technology.

FIG. 5B is a schematic plan view of a multilayer member according to an embodiment of the present technology.

FIG. 6A is a schematic illustration for explaining a bending test performed in a battery according to an embodiment of the present technology.

FIG. 6B is a schematic illustration for explaining the bending test performed in a battery according to an embodiment of the present technology.

FIG. 7A is a graph shown in the results of the bending test of a battery according to an embodiment of the present technology and a battery of Comparative Example 1A.

FIG. 7B is a graph showing the results of the complex impedance measurement of the battery according to an embodiment of the present technology.

FIG. 7C is a graph showing the results of the complex impedance measurement of the battery of Comparative Example 1A.

FIG. 8A is a photograph showing the appearance of the battery according to an embodiment of the present technology after the bending test.

FIG. 8B a photograph showing the appearance of the battery of Comparative Example 1A after the bending test.

FIG. 9A is a photograph showing the cross section of the battery according to an embodiment of the present technology before the bending test.

FIG. 9B is a photograph showing the cross section of the battery according to an embodiment of the present technology after the bending test.

FIG. 10 is a photograph showing the cross section of the battery of Comparative Example 1A after the bending test.

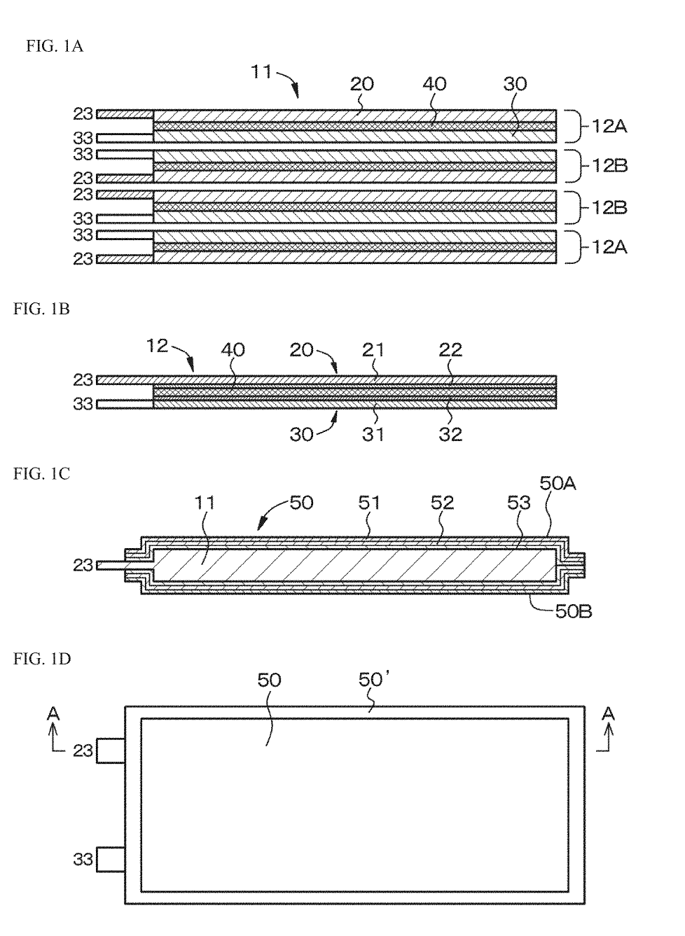

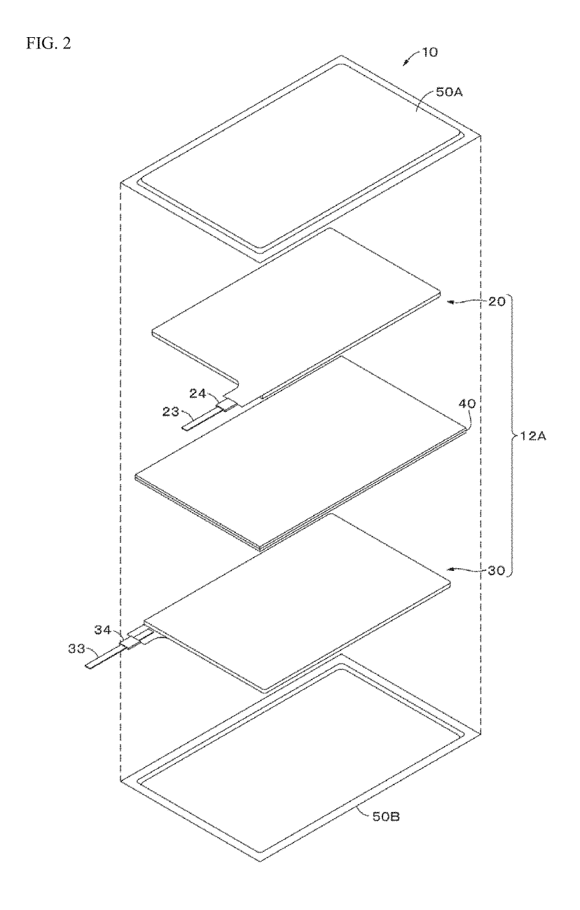

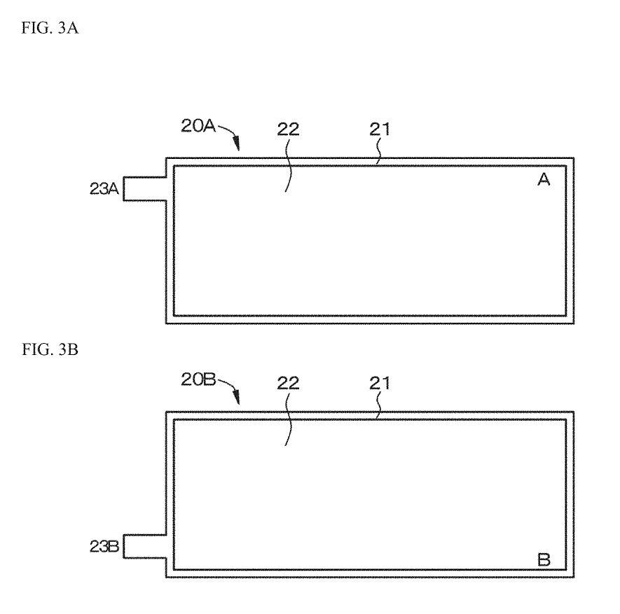

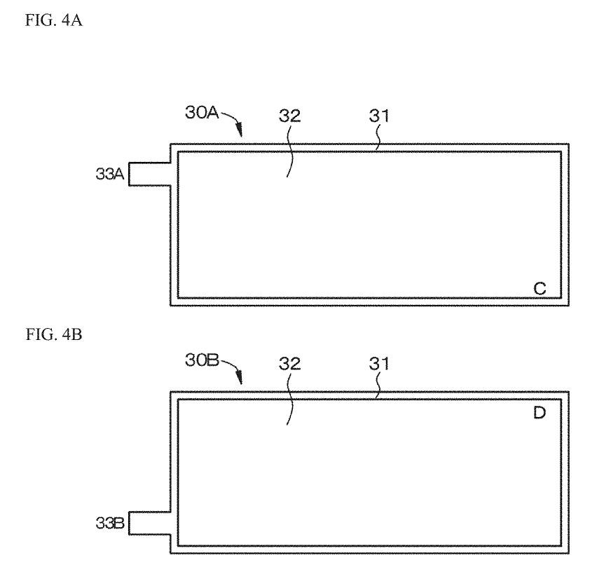

FIG. 1A is a schematic cross-sectional view of a multilayer member constituting a battery according to an embodiment of the present technology.

FIG. 11B is a schematic cross-sectional view of the battery according to an embodiment of the present technology.

FIG. 11C is a schematic plan view of the battery according to an embodiment of the present technology.

FIG. 12A is a schematic view illustrating the method of a bending test of a battery according to an embodiment of the present technology.

FIG. 12B is a schematic view illustrating the method of a bending test of a battery according to an embodiment of the present technology.

FIG. 13 shows graphs respectively showing the results of the evaluation of discharge capacity retention of batteries of Example 3A, Example 3B, Reference Example 3D, Reference Example 3E, Comparative Example 3A, Comparative Example 3B, Comparative Example 3D and Comparative Example 3E.

FIG. 14 shows graphs respectively showing the results of the evaluation of discharge capacity retention of batteries of Example 3A, Example 3C, Reference Example 3D, Reference Example 3F, Comparative Example 3A, Comparative Example 3C, Comparative Example 3D and Comparative Example 3F.

FIG. 15 is a block diagram illustrating an example of a circuit configuration according to an embodiment of the present technology.

FIG. 16A is a block diagram illustrating the configuration of an application example (an electric vehicle) according to an embodiment of the present technology.

FIG. 16B is a block diagram illustrating the configuration of an application example (an electric power storage system) according to an embodiment of the present technology.

FIG. 16C is a block diagram illustrating the configuration of an application example (an electric power tool) according to an embodiment of the present technology.

FIG. 17 is a perspective view illustrating one example of the configuration of a printed circuit board which is an application example according to an embodiment of the present technology.

FIG. 18 is a plan view illustrating one example of the appearance of a universal credit card which is one application example according to an embodiment of the present technology.

FIG. 19 is a plan view illustrating one example of the appearance of a wristband-type activity tracker which is one application example according to an embodiment of the present technology.

FIG. 20 is a block diagram illustrating one example of the configuration of a main body of the wristband-type activity tracker according to an embodiment of the present technology.

FIG. 21 is a perspective view showing one example of the appearance of a wristband-type electronic device which is an application example according to an embodiment of the present technology.

FIG. 22 is a block diagram illustrating one example of the wristband-type electronic device according to an embodiment of the present technology.

FIG. 23 is an exploded perspective view of a modification example according to an embodiment of the present technology.

FIG. 24 is a plan view illustrating one example of the appearance of a modification example according to an embodiment of the present technology.

FIG. 25A is a side view illustrating one example of the configuration of an electrode according to an embodiment of the present technology.

FIG. 25B is a side view illustrating one example of the connection form of a positive electrode lead according to an embodiment of the present technology.

### DETAILED DESCRIPTION

As described herein, the present disclosure will be described based on examples with reference to the drawings, but the present disclosure is not to be considered limited to the examples, and various numerical values and materials in the examples are considered by way of example.

The battery according to the first aspect of the present disclosure and the battery according to the first aspect of the present disclosure or the like which are provided in electronic devices according to the present disclosure are sometimes collectively referred to as “a battery according to the first aspect of the present disclosure or the like”. The battery according to the second aspect of the present disclosure and batteries according to the second aspect of the present disclosure which are provided in electronic devices according to the present disclosure are sometimes collectively referred to as “a battery according to the second aspect of the present disclosure or the like”. The battery according to the third aspect of the present disclosure and batteries according to the third aspect of the present disclosure which are provided in electronic devices according to the present disclosure are sometimes collectively referred to as “a battery according to the third aspect of the present disclosure or the like”.

In a battery according to the first or third aspect of the present disclosure or the like, an electrolyte preferably has a liquid, gel-like or solid form.

In a battery according to the first or third aspect of the present disclosure or the like or a battery according to the second aspect of the present disclosure or the like which includes the above-mentioned preferred embodiment, an external packaging member may have a configuration composed of a resin layer, an intermediate layer and a heat-sealable material layer which are laminated in this order as observed from the outside. In the battery according to the first or second aspect of the present disclosure of the like, the resin layer may contain a polyester-based resin, and more specifically the resin layer may contain polyethylene terephthalate (PET). Alternatively, the resin layer may also contain polyethylene naphthalate (PEN), polyphenylene sulfide or polyimide, or may also contain a material composed of a mixture of various resins. Alternatively, the resin layer may also contain a laminate of different resins.

In the battery according to the third aspect of the present disclosure or the like which includes the above-mentioned preferred embodiments, the resin layer may contain at least one of polyethylene terephthalate (PET) and polyethylene naphthalate (PEN), or may be composed of a product prepared by the mixing of polyethylene terephthalate with polyethylene naphthalate. In this regard, the wording “mixing of a PET resin with a PEN resin” includes a physical mixing of these resins as well as a thermal treatment of these resins at melting temperatures of these resins and a chemical reaction of a PET resin with a PEN resin through melt blending (e.g., a transesterification reaction). The resin layer may contain a resin other than at least one of polyethylene terephthalate and polyethylene naphthalate, and preferably contains at least one of polyethylene terephthalate and polyethylene naphthalate as the main component thereof. The wording “main component” used herein means that the content of at least one of polyethylene terephthalate and polyethylene naphthalate in the resin layer is 50% by mass or more.

When the resin layer is composed of a polyethylene terephthalate resin or a polyethylene naphthalate resin, because these resins have harder hardness compared with resin materials (e.g., polypropylene, PP) which have been used as resin layers in the common laminate-film-type batteries, the shape retention performance of the intermediate layer against an external force can be improved and the occurrence of cracking in the intermediate layer can be reduced even when the battery is curled repeatedly. As a result, the hermeticity of the battery can be maintained and the invasion of water can be prevented, and therefore the deterioration of capacity retention against charge-discharge cycles can be prevented.

In the battery according to the third aspect of the present disclosure or the like, the thickness of the resin layer is more than 40 μm, preferably 45 μm or more, more preferably 50 μm or more. When the thickness of the resin layer is more than 40 μm, the occurrence of cracking in the intermediate layer can be reduced even if the battery is curled repeatedly, the hermeticity of the battery can be maintained and the invasion of water can be prevented, and accordingly the deterioration of capacity retention against charge-discharge cycles can be prevented. The upper limit of the thickness of the resin layer is 200 μm, preferably 150 μm, more preferably 100 μm. If the upper limit of the thickness of the resin layer is more than 200 μm, the battery may become too thick. Even though the thickness of the resin layer is not increase to more than 200 μm, the function to protect the surface of the external packaging member can be achieved sufficiently.

The thickness of the resin layer can be measured by the following method. Firstly, a cross section of the external packaging member is cleaved by FIB (Focused Ion Beam) processing or the like. The cross section is observed with a SEM (Scanning Electron Microscope), and the thickness of the resin layer contained in the external packaging member is determined.

The resin layer in the battery according to any one of the first to third aspects of the present disclosure or the like may be a monoaxially stretched film or a biaxially stretched film.

Furthermore, in the configuration in the battery according to any one of the first to third aspects of the present disclosure or the like, the intermediate layer may be made from aluminum, an aluminum alloy, stainless steel, copper, a copper alloy, nickel or a nickel alloy, and is particularly preferably made from aluminum or an aluminum alloy.

Furthermore, in the battery according to the first aspect of the present disclosure or the like which includes the above-mentioned various preferred embodiments and configurations, the multilayer members may be connected in parallel with each other in the multilayer structure.

In the battery according to any one of the first to third aspects of the present disclosure or the like which includes the above-mentioned various preferred embodiments and configurations, an adhesive agent layer (also referred to as “first adhesive agent layer” for convenience) may be provided between the resin layer and the intermediate layer, or a second adhesive agent layer may be provided between the intermediate layer and the heat-sealable material layer. Each of the first adhesive agent layer and the second adhesive agent layer is made from, for example, an acrylic adhesive agent, a polyester-based adhesive agent or a polyurethane-based adhesive agent. The first adhesive agent layer may be provided on the whole area of the interface between the resin layer and the intermediate layer, or may have empty spaces (empty spaces, openings or through-holes which penetrate through the first adhesive agent layer as observed in the thickness direction) from the viewpoint of the improvement in flexibility and bendability of the battery. In other words, the empty spaces may be provided in the adhesive agent layer in the thickness direction. The empty spaces may be distributed in the whole area of the interface between the resin layer and the intermediate layer and may be arranged in a regular pattern or randomly. The planar form of the empty spaces is, for example, a net-like form, a grid-like form, a stripe-like form, an island-like form, a concentric form, a spiral form, a radial form, a dot-like form, a geometric pattern-like form or an amorphous form, but is not limited these forms. With respect to the second adhesive agent layer, the same matter can apply.

The external packaging member may further include a colored layer outside relative to the intermediate layer or a coloring material may be contained in at least one of the resin layer, the first adhesive agent layer and the intermediate layer, from the viewpoint of good appearance and the like. The colored layer or the coloring material may have a specific design.

In the battery according to the first aspect of the present disclosure which includes the above-mentioned various preferred embodiments and configurations, a plurality of the multilayer members are stacked in such a manner that current collectors having the same polarity face each other. Optionally, it is also possible to insert a film having SiOₓ or Al₂O₃ deposited thereon between the second surfaces of the current collectors that face each other or to arrange SiOₓ or Al₂O₃ microparticles (an antifriction material) between the second surfaces of the current collectors that face each other, so that the second surfaces of the current collectors can move (slide) relative to each other more easily. In the battery according to the second or third aspect of the present disclosure which includes the above-mentioned various preferred embodiments and configurations, it is also possible to use a multilayer structure in which a plurality of the multilayer members are stacked in such a manner that the current collectors having the same polarity can face each other. In other words, the external packaging member may be configured so as to cover a multilayer structure including a plurality of multilayer members, wherein each of the multilayer members includes a positive electrode mix layer and a negative electrode mix layer arranged so as to face each other and the multilayer members are stacked in such a manner that current collectors having the same polarity can face each other. In this case, the multilayer members may be connected in parallel with each other in the multilayer structure.

In the battery according to any one of the first to third aspects of the present disclosure which includes the above-mentioned various preferred embodiments and configurations (wherein the battery is sometimes collectively referred to as “battery according to the present disclosure or the like”), it is desirable that the thickness of the battery is 1 mm or less, preferably 0.7 mm or less, more preferably 0.5 mm or less. When the thickness of the battery is 1 mm or less, the difference in the perimeters of both surfaces of the battery can be reduced when the battery is curled, and the occurrence of wrinkling in the external packaging member can be reliably prevented. When wrinkling occurs in the external packaging member, the breakage of the external packaging member, the detachment of the electrodes, the deterioration in appearance and the like may occur.

In the battery according to the present disclosure or the like, the external packaging member is composed of a resin layer (surface protection layer), an intermediate layer (moisture-proof layer, barrier layer) and a heat-sealable material layer (melting layer, melting layer) which are laminated in this order as observed from the outside. For the covering (sealing) of the multilayer structure or the multilayer members with the external packaging member, the multilayer structure or the multilayer members are placed at the center of the heat-sealable material layer and then peripheries of the heat-sealable material layer are fusion-bonded, for example. The heat-sealable material layer may be made from, for example, a film of an olefin resin such as polyethylene, polypropylene, modified polyethylene, modified polypropylene or a polymer of any one of these materials. It is possible to bond the resin layer to the intermediate layer alternately or bond the intermediate layer to the heat-sealable material layer alternately with an adhesive agent.

Specific examples of the shape of the battery according to the present disclosure or the like include a flat-plate-like form, a sheet-like form and the like. The sheet-like form includes a curled form. In other words, a battery that is curled from the beginning is also included. In addition, the outer shape of the battery according to the present disclosure or the like also includes a rectangular form as well as an amorphous form, and may be basically any outer shape.

The separator can separate the positive electrode member and the negative electrode member from each other and allows ions to pass while preventing the short circuit of current which may be caused by the contact of the positive electrode member with the negative electrode member. The separator is formed from, for example: a porous film made from a synthetic resin such as a polyolefin-based resin (e.g., a polypropylene resin, a polyethylene resin), an acrylic resin, a styrene resin, a polyester resin, a nylon resin, a polyimide resin, a polytetrafluoroethylene resin, a polyvinylidene fluoride resin, a polyphenylene sulfide resin and an aromatic polyamide; a porous film made from a ceramic or the like; a glass fiber (including a glass filter); a non-woven fabric made from a liquid crystal polyester fiber, an aromatic polyamide fiber or a cellulose-based fiber; and a non-woven fabric made from a ceramic. Alternatively, the separator may be formed from a laminate film composed of at least two kinds of porous films laminated on each other, or may be a separator having an inorganic material layer applied thereon or an inorganic material-containing separator. Among these materials, a porous film made from a polyolefin-based resin is preferred, because the porous film has an excellent short circuit prevention effect and can improve the safety of the battery due to the shut-down effect thereof. The polyethylene resin can exhibit the shut-down effect thereof at a temperature ranging from 100 to 160° C., and has excellent electrochemical stability. For these reasons, the polyethylene resin is particularly preferred as the material constituting the separator. In addition, a material produced by copolymerizing or blending a resin having chemical stability with polyethylene or polypropylene can also be used. Alternatively, the porous film may have a three-layered or higher structure composed of, for example, a polypropylene resin layer, a polyethylene resin layer and a polypropylene resin layer which are laminated in this order. The thickness of the separator is preferably 5 to 50 μm inclusive, more preferably 7 to 30 μm inclusive. If the separator is too thick, the amount of the active material to be filled may be decreased, and therefore the battery capacity may be decreased, and ion conductivity may also be deteriorated, resulting in the deterioration in current properties. If the separator is too thin, the mechanical strength of the separation may be deteriorated.

Alternatively, it is also possible that the separator includes a base and a surface layer formed on the surface of the base, wherein the surface layer is composed of inorganic particles and a resin material. Namely, the separator may have such a structure that a surface layer is provided on one surface or both surfaces of a base. As the surface layer, a porous matrix surface layer having an inorganic material carried thereon can be mentioned. Namely, the surface layer contains inorganic particles having electric insulation properties and a resin material for carrying the inorganic particles on the surface of the base. The resin material may be fibrillated so as to have a three-dimensional network structure in which fibrils are continuously connected to each other. When the inorganic particles are carried on the resin material having the three-dimensional network structure, the inorganic particles can remain in a dispersed state while preventing the contact therebetween. Alternatively, the resin material may not be fibrillated. When the surface layer is provided on one surface or both surfaces of the base, it becomes possible to impart oxidation resistance, heat resistance and mechanical strength to the base and therefore the deterioration of the separator can be prevented.

Alternatively, the base is made from a porous material having porosity. More specifically, the base is made from an insulating film having high ion permeability and specific mechanical strength, wherein the electrolyte solution is carried in pores in the base. The base acts as the main part of the separator and therefore has a certain level of mechanical strength, and preferably also has properties including high resistance to an electrolyte solution, low reactivity and uneasiness to be swollen.

As the resin material constituting the base, a polyolefin-based resin such as a polypropylene resin and a polyethylene resin, an acrylic resin, a styrene resin, a polyester resin or a nylon resin can be used preferably. Particularly, polyethylene, such as low-density polyethylene, high-density polyethylene and linear polyethylene, or a low-molecular-weight wax fraction thereof, or a polyolefin-based resin such as polypropylene can be used preferably, because the material has a proper melting temperature and is easily available. At least two of these porous films may be laminated, or at least two resin materials may be melt-kneaded to form a porous film. A porous film made from a polyolefin-based resin has an excellent property to separate the positive electrode member from the negative electrode member and can further reduce the deterioration in internal short circuit. As the base, a non-woven fabric may be used. As the fibers constituting the non-woven fabric, aramid fibers, glass fibers, polyolefin fibers, polyethylene terephthalate (PET) fibers, nylon fibers and the like can be used. Alternatively, a mixture of two or more of these fibers may be used as the non-woven fabric.

Alternatively, specific examples of the material constituting the matrix surface layer include polyvinylidene fluoride (PVdF), hexafluoropropylene (HFP) and polytetrafluoroethylene (PTFE). Copolymers of these compounds may also be used.

As the inorganic particles, particles of a metal, a semiconductor or an oxide, a nitride, a carbide or a sulfide thereof can be mentioned. Specific examples of the metal include aluminum (Al) and titanium (Ti), and specific examples of the semiconductor include silicon (Si) and boron (B). It is preferred that the inorganic particles do not substantially have electric conductivity and has a large heat capacity. When the inorganic particles have a large heat capacity, the inorganic particles act as a useful heatsink upon current heating, and can prevent the thermal runaway of the battery more effectively. Specific examples of the inorganic particles include particles of an oxide, such as alumina (Al₂O₃), boehmite (alumina monohydrate), magnesium oxide (magnesia, MgO), zirconium oxide (zirconia, ZrO₂), silicon oxide (silica, SiO₂), yttrium oxide (yttria, Y₂O₃), titanium dioxide (titania, TiO₂), talc, boron nitride (BN), aluminum nitride (AlN), silicon nitride (Si₃N₄), titanium nitride (TiN), silicon carbide (SiC), boron carbide (B₄C) and barium sulfate (BaSO₄); and a nitride, a carbide and a sulfide. In addition, a porous aluminosilicate such as zeolite (M_{2/n}O.Al₂O₃.xSiO₂.yH₂O, wherein M represents a metal element, x≥2, y≥0), a layered silicate, and a mineral such as barium titanate (BaTiO₃) and strontium titanate (SrTiO₃) can also be used. Among these substances, alumina, titania (particularly having rutile-type structure), silica or magnesia can be used preferably, and alumina can be used more preferably. The inorganic particles have oxidation resistance and heat resistance, and the surface layer that faces the positive electrode member and contains inorganic particles has strong resistance to an oxidative environment in the vicinity of the positive electrode member during charging. The shape of each of the inorganic particles is not particularly limited, and may be any one of a spherical form, a plate-like form, a fibrous form, a cubic form, a random form and the like. The particle diameter of each of the inorganic particles is 1 nm to 10 μm. If the particle diameter is smaller than 1 nm, the inorganic particles are not easily available and, if obtained, the cost is disproportionate. If the particle diameter is larger than 10 μm, the distance between the electrodes becomes long, therefore a sufficient active material filled amount cannot be achieved within a limited space, and the battery capacity is reduced. The inorganic particles may be contained in a porous film that serves as a base. The surface layer can be produced by applying a slurry composed of, for example, a matrix resin, a solvent and inorganic particles onto a base (porous film), then allowing the resultant product to pass through a poor solvent for the matrix resin and a bath containing a parent solvent for the solvent to cause phase separation, and then drying the resultant product.

Examples of the resin material constituting the surface layer include resins each having such high heat resistance that at least one of the melting point and the glass transition temperature is 180° C. or higher, such as a fluorine-containing resin including polyvinylidene fluoride and polytetrafluoroethylene, a fluorine-containing rubber including a (vinylidene fluoride)-tetrafluoroethylene copolymer and an ethylene-tetrafluoroethylene copolymer, a rubber including a styrene-butadiene copolymer or a hydride thereof, an acrylonitrile-butadiene copolymer or a hydride thereof, an acrylonitrile-butadiene-styrene copolymer or a hydride thereof, a (methacrylic acid ester)-(acrylic acid ester) copolymer, a styrene-(acrylic acid ester) copolymer, an acrylonitrile-(acrylic acid ester) copolymer, an ethylene propylene rubber, polyvinyl alcohol and polyvinyl acetate, a cellulose derivative including ethyl cellulose, methyl cellulose, hydroxyethyl cellulose and carboxymethyl cellulose, polyphenylene ether, polysulfone, polyether sulfone, polyphenylene sulfide, polyether imide, polyimide, a polyamide including wholly aromatic polyamide (aramid), polyamideimide, polyacrylonitrile, polyvinyl alcohol, polyether, an acrylic acid resin and a polyester. These resin materials may be used singly, or two or more of them may be used in the form of a mixture. Among these compounds, a fluorine-based resin such as polyvinylidene fluoride is preferred from the viewpoint of oxidation resistance and flexibility, and it is preferred to contain aramid or polyamideimide from the viewpoint of heat resistance.

The inorganic particles may be contained in a porous film that serves as a base. The surface layer may not contain inorganic particles and may be composed of only a resin material.

The battery may also have such a configuration that the positive electrode member and the base are bonded together with the surface layer provided on one surface of the base interposed therebetween and the negative electrode member and the base are bonded together with the surface layer provided on the other surface of the base interposed therebetween. Namely, the battery may have such a configuration that a portion of the polymeric compound contained in the surface layer is diffused in the positive electrode mix layer and the negative electrode mix layer to integrate the separator, the positive electrode member and the negative electrode member together. Alternatively, the battery may have such a configuration that a part of the base and a part of the positive electrode member are bonded together and a part of the base and a part of the negative electrode member are bonded together. According to these configurations, the adhesion force between the positive electrode member and the negative electrode member can be improved, the occurrence of detachment between the positive electrode member and the negative electrode member can be prevented even when the battery is curled repeatedly, and the deterioration in cycle properties when the battery is curled repeatedly can be prevented.

The puncture strength of the separation is 100 gf to 1 kgf, preferably 100 to 480 gf. If the puncture strength is too low, short circuit may occur. If the puncture strength is too high, ion conductivity may be deteriorated. The gas permeability of the separator is 30 to 1000 sec/100 cc, preferably 30 to 680 sec/100 cc. If the gas permeability is too low, short circuit may occur. If the gas permeability is too high, ion conductivity may be deteriorated.

In the battery according to any one of the first to third aspects of the present disclosure which includes the above-mentioned various preferred embodiments and configurations, the electrolyte may contain inorganic particles. One example of the inorganic particles is inorganic particles that constitute the above-mentioned surface layer.

In the battery according to the present disclosure or the like, specific examples of the material constituting the positive electrode current collector include copper (Cu), aluminum (Al), nickel (Ni), magnesium (Mg), titanium (Ti), iron (Fe), cobalt (Co), zinc (Zn), germanium (Ge), indium (In), gold (Au), platinum (Pt), silver (Ag), palladium (Pd), an alloy containing any one of these materials, or a conductive material such as stainless steel. A positive electrode lead part can be attached to the positive electrode current collector. Specific examples of the material constituting the negative electrode current collector include copper (Cu), aluminum (Al), nickel (Ni), magnesium (Mg), titanium (Ti), iron (Fe), cobalt (Co), zinc (Zn), germanium (Ge), indium (In), gold (Au), platinum (Pt), silver (Ag), palladium (Pd), an alloy containing any one of these materials, and a conductive material such as stainless steel. A negative electrode lead part can be attached to the negative electrode current collector. Examples of the form of the positive electrode current collector or the negative electrode current collector include a foil-like material, a non-woven fabric-like material, a net-like material and a porous sheet-like material.

It is preferred that the surface of the negative electrode current collector is roughened from the viewpoint that the adhesiveness of the negative electrode mix layer to the negative electrode current collector can be improved through the so-called anchor effect. In this case, it is enough to roughen at least the surface of a region of the negative electrode current collector on which the negative electrode mix layer is to be formed. One example of the method for the roughening is a method in which microparticles are formed utilizing an electrolytic treatment. An electrolytic treatment is a treatment in which microparticles are formed on the surface of the negative electrode current collector in an electrolytic vessel utilizing an electrolytic method to form unevenness on the surface of the negative electrode current collector.

A positive electrode lead part can be attached to the positive electrode current collector by spot welding or ultrasonic welding. The positive electrode lead part is desirably a metal foil or a net-like form, and may not be a metal as long as the material is electrochemically and chemically stable and can be electrically conductive. Specific examples of the material for the positive electrode lead part include aluminum (Al), nickel (Ni) and stainless (SUS). A negative electrode lead part can also be attached to the negative electrode current collector by spot welding or ultrasonic welding. The negative electrode lead part is also desirably a metal foil or a net-like form, and may not be a metal as long as the material is electrochemically and chemically stable and can be electrically conductive. Specific examples of the material for the negative electrode lead part include copper (Cu) and nickel (Ni). The positive electrode lead part or the negative electrode lead part can be formed from an overhanging part which is formed by protruding a part of the negative electrode current collector or the negative electrode current collector from the positive electrode current collector or the negative electrode current collector, respectively.

It is also possible to insert an adhesive film between the external packaging member and each of the positive electrode lead part and the negative electrode lead part (an overhanging part which formed by protruding a part of each of the positive electrode current collector and the negative electrode current collector from each of the positive electrode current collector and the negative electrode current collector) for the purpose of preventing the invasion of outdoor air. The adhesive film may be made from a material having close bondability to the positive electrode lead part and the negative electrode lead part, such as a polyolefin-based resin including polyethylene, polypropylene, modified polyethylene and modified polypropylene.

The positive electrode mix layer contains a positive electrode active material. The positive electrode mix layer may additionally contain a positive electrode binder, a positive electrode conductive agent or the like. Similarly, the negative electrode mix layer contains a negative electrode active material. The negative electrode mix layer may additionally contain a negative electrode binder, a negative electrode conductive agent or the like.

As the battery according to the present disclosure or the like, a lithium ion secondary battery can be exemplified. However, the battery according to the present disclosure or the like is not limited to a lithium ion secondary battery, and includes a magnesium ion battery, a metal air secondary battery which has a negative electrode member that contains a negative electrode active material containing a metal and an alloy material (wherein specific examples of the metal and the alloy material that can be used for the negative electrode active material include tin, silicon; an alkali metal such as lithium, sodium and potassium; an element belonging to Group 2, such as magnesium and calcium; an element belonging to Group 13, such as aluminum; a transition metal element such as zinc and iron; and alloy materials and compounds containing these metals), a lithium-sulfur secondary battery, a sodium-sulfur secondary battery, a sodium-(nickel chloride) secondary battery, a sodium ion secondary battery, a polycation secondary battery, various organic secondary batteries, a nickel-hydrogen secondary battery.

The electrolyte contains a non-aqueous electrolyte solution and a polymeric compound capable of carrying the non-aqueous electrolyte solution (e.g., a resin material), wherein the polymeric compound is swollen with the non-aqueous electrolyte solution. The content of the polymeric compound for carrying use can be controlled as appropriately. The polymeric compound that is swollen with the non-aqueous electrolyte solution may have a gel-like or solid form. The electrolyte having a gel-like or solid form is preferred, because the electrolyte can achieve a high ion conductivity (e.g., 1 mS/cm or more at room temperature) and can prevent the leakage of the electrolyte solution from the secondary battery 10.

The non-aqueous electrolyte solution contains a non-aqueous solvent and an electrolyte salt. For the purpose of improving the properties of the battery, the non-aqueous electrolyte solution may additionally contain a known additive.

In the case where the battery according to the present disclosure or the like which includes the above-mentioned preferred forms and configurations is used as a lithium ion battery in which the capacity of a negative electrode member can be obtained through the storage and release of lithium that is an electrode reaction product, the constituent elements of the battery will be described as follows. In a lithium ion battery, during charging, lithium ions are released from a positive electrode active material and are stored in a negative electrode active material through a non-aqueous electrolyte solution, for example. During discharging, lithium ions are released from the negative electrode active material and are stored in the positive electrode active material through the non-aqueous electrolyte solution, for example.

The positive electrode active material contains, for example, a positive electrode active material capable of storing and releasing lithium (Li) ions that are an electrode reaction product. Specific examples of the positive electrode active material capable of storing and releasing lithium ions include lithium-containing compounds, such as a lithium-containing composite oxide, a lithium-containing phosphoric acid compound, a lithium-containing sulfide and a lithium-containing interlayer compound, and at least two of these compounds may be used in the form of a mixture. Alternatively, as the positive electrode active material, a lithium-containing compound (a compound containing a lithium atom) can be mentioned. From the viewpoint that a high energy density can be achieved, it is preferred to use a lithium-containing composite oxide or a lithium-containing phosphoric acid compound. A lithium-containing composite oxide is an oxide containing lithium and at least one element (also referred to as “other element”, hereinafter) as constituent elements, and has a layered rock salt-type crystal structure or a spinel-type crystal structure. Specific examples of the lithium-containing composite oxide include a lithium-cobalt-based material, a lithium-nickel-based material, a spinel manganese-based material and a material having a superlattice structure. A lithium-containing phosphoric acid compound is a phosphoric acid compound containing lithium and at least one element (other element) as constituent elements, and has an olivine-type crystal structure. For the purpose of increasing the energy density, a lithium-containing compound containing lithium, a transition metal element and oxygen (O) is preferred. Examples of the lithium-containing compound of this type include a lithium composite oxide having a layered rock salt-type structure which is represented by formula (A) and a lithium composite phosphoric acid salt having an olivine-type structure which is represented by formula (B). It is more preferred that the transition metal element in the lithium-containing compound includes at least one element selected from the group consisting of cobalt (Co), nickel (Ni), manganese (Mn) and iron (Fe). Examples of the lithium-containing compound of this type include a lithium composite oxide having a layered rock salt-type structure which is represented by formula (C), formula (D) or formula (E), a lithium composite oxide having a spinel-type structure which is represented by formula (F), and a lithium composite phosphoric acid salt having an olivine-type structure which is represented by formula (G).

Specific examples of the lithium-containing composite oxide having a layered rock salt-type crystal structure include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{c1}Ni_{c2}Co₁₋ₑ₂O₂(c1≈1, 0<c2<1), Li_{1.2}Mn_{0.52}Co_{0.175}Ni_{0.1}O₂, Li_{1.15} (Mn_{0.65}Ni_{0.22}Co_{0.13})O₂, Li_{d}Mn₂O₄(d≈1) and LiₑFePO₄ (e≈1).

LiₚNi_{(1-q-r)}Mn_{q}M¹ᵣO_{(2-y)}X_{z} (A)

In formula (A), M¹ represents at least one element selected from elements belonging to Groups 2 to 15 excluding nickel (Ni) and manganese (Mn). X represents at least one element selected from elements belonging to Groups 16 and 17 excluding oxygen (O). p, q, y and z respectively represent numerical values falling within the following ranges: 0≤p≤1.5; 0≤q≤1.0; 0≤r≤1.0; −0.10≤y≤0.20 and 0≤z≤0.2.

LiₐM²_{b}PO₄ (B)

In formula (B), M² represents at least one element selected from elements belonging to Groups 2 to 15. a and b respectively represent numerical values falling within the following ranges:

0≤a≤2.0; and

0.5≤b≤2.0.

Li_{f}Mn_{(1-g-h)}Ni_{g}M³ₕO₍₂₋ⱼ₎Fₖ (C)

In formula (C), M³ represents at least one element selected from the group consisting of cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr) and tungsten (W). f, g, h, j and k respectively represent numerical values falling within the following ranges:

0.8≤f≤1.2;

0<g<0.5;

0≤h≤0.5;

(g+h)<1;

−0.1≤j≤0.2; and

0≤k≤0.1.

The chemical composition shown in formula (C) varies depending on whether the battery is in a charged state or a discharged state, and f represents a value obtained in a completely discharged state.

LiₘNi₍₁₋ₙ₎M⁴ₙO₍₂₋ₚ₎F_{q} (D)

In formula (D), M⁴ represents at least one element selected from the group consisting of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W). m, n, p and q respectively represent numerical value falling within the following ranges:

0.8≤m≤1.2;

0.005≤n≤0.5;

−0.1≤p≤0.2; and

0≤q≤0.1.

The chemical composition shown in formula (D) varies depending on whether the battery is in a charged state or a discharged state, and m represents a value obtained in a completely discharged state.

LiᵣCO₍₁₋ₛ₎M⁵ₛO₍₂₋ₜ₎Fᵤ (E)

In formula (E), M⁵ represents at least one element selected from the group consisting of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W). r, s, t and u respectively represent numerical values falling within the following ranges:

0.8≤r≤1.2;

0≤s≤0.5;

−0.1≤t≤0.2; and

0≤u≤0.1.

The chemical composition shown in formula (E) varies depending on whether the battery is in a charged state or a discharged state, and r represents a value obtained in a completely discharged state.

LiᵥMn_{2-w}M⁶_{w}OₓF_{y} (F)

In formula (F), M⁶ represents at least one element selected from the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W). v, w, x and y respectively represent numerical values falling within the following ranges:

0.9≤v≤1.1;

0≤w≤0.6;

3.7≤x≤4.1; and

0≤y≤0.1.

The chemical composition shown in formula (F) varies depending on whether the battery is in a charged state or a discharged state, and v represents a value obtained in a completely discharged state.

Li_{z}M⁷PO₄ (G)

In formula (G), M⁷ represents at least one element selected from the group consisting of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W) and zirconium (Zr). Z represents a numerical value falling within the range: 0.9≤z≤1.1. The chemical composition shown in formula (G) varies depending on whether the battery is in a charged state or a discharged state, and z represents a value obtained in a completely discharged state.

In addition to these compounds, examples of the positive electrode active material capable of storing and releasing lithium also include a lithium-free inorganic compound such as MnO₂, V₂O₅, V₆O₁₃, NiS and MoS. The positive electrode active material capable of storing and releasing lithium may also be a compound other than the above-mentioned compounds. Alternatively, an arbitrary combination of at least two of the above-exemplified positive electrode active materials may be used in the form of a mixture.

An example of the negative electrode active material is a carbon material. The carbon material shows an extremely small change in crystal structure upon the storage and release of lithium, and therefore a high energy density can be achieved steadily. Furthermore, the carbon material can also act as the negative electrode conductive agent, and therefore the electric conductivity of the negative electrode mix layer can be improved. Specific examples of the carbon material include easily graphitizable carbon (soft carbon), hardly graphitizable carbon (hard carbon), graphite, and a highly crystalline carbon material having an advanced crystal structure. It is preferred that the lattice spacing of (002) plane of hardly graphitizable carbon is 0.37 nm or more. It is also preferred that the lattice spacing of (002) plane of graphite is 0.34 nm or less. More specific examples of the carbon material include: a pyrolytic carbon-type substance; a coke-type substance such as pitch coke, needle coke and petroleum coke; a graphite-type substance; a glass-like carbon fiber; a fired organic polymeric compound which is produced by firing (carbonizing) a polymeric compound, e.g., a phenolic resin and a furan resin, at an appropriate temperature; a carbon fiber; activated carbon; a carbon black-type substance; and a polymer such as polyacetylene and polypyrrole. Specific examples of graphite include spheroidized natural graphite and approximately spherical artificial graphite. Specific examples of the artificial graphite include artificial graphite produced by graphitizing meso-carbon micro-beads (MCMBs) and artificial graphite produced by graphitizing and grinding a coke raw material. In addition, as the carbon material, low-crystalline carbon that is thermally treated at a temperature of about 1000° C. or lower can be mentioned, and amorphous carbon can also be mentioned. The shape of the carbon material may be any one selected from a fibrous form, a spherical form, a granular form and a scale-like form. These carbon materials are preferred, because these carbon materials show little change in crystal structure thereof which may be caused during charging and discharging, can achieve a high charge-discharge capacity and can achieve good cycle properties. Graphite is particularly preferred, because graphite has a large electrochemical equivalent and can achieve a high energy density. Hardly graphitizable carbon is preferred, because excellent properties can be achieved. Furthermore, a carbon material having a low charge-discharge potential, specifically a carbon material having a charge-discharge potential close to that of lithium metal, is preferred, because the energy density of the battery can be increased easily.

As the negative electrode active material, a material containing at least one of a metal element and a half metal element as a constituent element (wherein the material is referred to as “metal-based material”, hereinafter) can also be mentioned. The metal-based material can achieve a high energy density. The metal-based material may be in the form of any one of an element, an alloy and a compound, or may be a material composed of two or more of these components, or may be a material which contains a phase containing at least one of these components as a part thereof. The alloy includes a material composed of two or more metal elements and a material composed of at least one metal element and at least one half metal element. The alloy may contain a non-metal element. The texture of the metal-based material is, for example, a solid solution, a eutectic material (a eutectic mixture), an intermetallic compound and a coexistent substance of two or more of them. When these materials are used, a high energy density can be achieved. Particularly, the use of the metal-based material in combination with the carbon material is more preferred, because a higher energy density can be achieved and cycle properties can be improved.

As the metal element or the half metal element, a metal element or half metal element which can form an alloy in conjunction with lithium can be mentioned. Specific examples of the metal element and the half metal element include magnesium (Mg), boron (B), aluminum (Al), gallium (Ga), indium (In), silicon (Si), germanium (Ge), tin (Sn), lead (Pb), antimony (Sb), bismuth (Bi), cadmium (Cd), silver (Ag), zinc (Zn), hafnium (Hf), zirconium (Zr), yttrium (Y), palladium (Pd) and platinum (Pt). Among these elements, silicon (Si) and tin (Sn) are preferred, because the ability to store and release lithium is excellent and a significantly high energy density can be achieved. These materials may be crystalline or amorphous.

As the negative electrode material, a negative electrode material containing a metal element or half metal element belonging to Group 4B on the short format of periodic table as the constituent element thereof is preferred, and a negative electrode material containing at least one of silicon (Si) and tin (Sn) as the constituent element thereof is particularly preferred. This is because silicon (Si) and tin (Sn) have a high ability to store and release lithium (Li) and therefore a high energy density can be achieved.

Specific examples of the material containing silicon as the constituent element thereof include element silicon, a silicon alloy and a silicon compound, and also include a material composed of at least two of element silicon, a silicon alloy and a silicon compound, or a material that contains, as at least a portion thereof, a phase composed of at least one of element silicon, a silicon alloy and a silicon compound. Specific examples of the material containing tin as the constituent element thereof include element tin, a tin alloy and a tin compound, and also include a material composed of at least two of element tin, a tin alloy and a tin compound, or a material that contains, as at least a portion thereof, a phase composed of at least one of element tin, a tin alloy and a tin compound. The term “element” refers to just an element in the common sense, and may contain a trace amount of impurities and does not always mean an element having purity of 100%.

Specific examples of the non-silicon element constituting the silicon alloy or the silicon compound include tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr), and also include carbon (C) and oxygen (O).

Specific examples of the silicon alloy and the silicon compound include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOv (0<v≤2, preferably 0.2<v<1.4) and LiSiO.

Specific examples of the non-tin element constituting the tin alloy or the tin compound include silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr), and also include carbon (C) and oxygen (O). Specific examples of the tin alloy and the tin compound include SnO_{w} (0<w≤2), SnSiO₃, LiSnO and Mg₂Sn. Particularly, the material containing tin as the constituent element thereof is preferably, for example, a material containing tin (a first constituent element) as well as a second constituent element and a third constituent element (wherein the material is referred to as a “Sn-containing material”, hereinafter). Specific examples of the second constituent element include cobalt (Co), iron (Fe), magnesium (Mg), titanium (Ti), vanadium (V), chromium (Cr), manganese (Mn), nickel (Ni), copper (Cu), zinc (Zn), gallium (Ga), zirconium (Zr), niobium (Nb), molybdenum (Mo), silver (Ag), indium (In), cesium (Ce), hafnium (Hf), tantalum (Ta), tungsten (W), bismuth (Bi) and silicon (Si), and specific examples of the third constituent element include boron (B), carbon (C), aluminum (Al) and phosphorus (P). When the Sn-containing material contains the second constituent element and the third constituent element, a high battery capacity, excellent cycle properties and the like can be achieved.

Particularly, the Sn-containing material is preferably a material that contains tin (Sn), cobalt (Co) and carbon (C) as the constituent elements thereof (wherein the material is referred to as an “Sn—Co—C-containing material”, hereinafter). In the Sn—Co—C-containing material, the content of carbon is, for example, 9.9 to 29.7% by mass and each of the content ratio between tin and cobalt (which represented by the formula: Co/(Sn+Co)) is 20 to 70% by mass. This is because a high energy density can be achieved. It is preferred that the Sn—Co—C-containing material has a phase containing tin, cobalt and carbon, wherein the phase is low crystalline or amorphous. The phase is a phase capable of reacting with lithium (i.e., a reactive phase), and therefore excellent properties can be achieved due to the presence of the reactive phase. It is preferred that the half bandwidth (diffraction angle: 2θ) of a diffraction peak of the reactive phase as measured by X-ray diffraction is 1° or more when CuKα line is used as a specific X-ray and the scanning rate is 1°/min. This is because, in the Sn—Co—C-containing material, lithium can be stored/released more smoothly and the reactivity of the Sn—Co—C-containing material with the non-aqueous electrolytic solution can be reduced. In addition to the low crystalline or amorphous phase, the Sn—Co—C-containing material may also contain a phase that contains elements of the constituent elements thereof or some of the elements.

Whether or not a diffraction peak obtained by the X-ray diffraction corresponds to a reactive phase capable of reacting with lithium can be determined easily by, for example, comparing X-ray diffraction charts before and after the electrochemical reaction with lithium with each other. For example, when the position of a diffraction peak is shifted before and after the electrochemical reaction with lithium, it is determined that the diffraction peak corresponds to a reactive phase capable of reacting with lithium. In this case, a diffraction peak of the low crystalline or amorphous reactive phase appears at an angle 2θ between 20° to 50°. It is considered that this reactive phase contains, for example, the above-mentioned constituent elements and becomes low crystalline or amorphous mainly due to the presence of carbon.

In the Sn—Co—C-containing material, it is preferred that at least some of carbon atoms, which are constituent elements, are bonded to the metal element or the metalloid that is another constituent element. This is because the coagulation or crystallization of tin or the like can be prevented. The state of binding between the elements can be confirmed by employing, for example, an X-ray photoelectron spectroscopy (XPS) using Al-Kα line, Mg-Kα line or the like as a soft X-ray. In the case where at least some of carbon atoms are bonded to a metal element, a metalloid or the like, the peak corresponding to an associated wave of 1s orbit (C1s) of a carbon atom appears in a region lower than 284.5 eV. In this regard, the peak corresponding to 4f orbit (Au4f) of a gold atom is energy-calibrated so as to appear at 84.0 eV. In general, a surface-contaminating carbon atom is present on the surface of a substance. Therefore, it is defined that the peak corresponding to C1s of the surface-contaminating carbon atom appears at 284.8 eV, and the peak is employed as an energy base. In the XPS measurement, the wave form of the peak corresponding to C1s can be defined by a form including a peak corresponding to the surface-contaminating carbon atom and a peak corresponding to a carbon atom contained in the Sn—Co—C-containing material. The two peaks can be separated by the analysis using a commercially available software. In the analysis of a wave form, the position of a main peak appearing on the minimum binding energy side is employed as an energy base (284.8 eV).

The SnCoC-containing material is not limited to those materials (SnCoC) in each of which the constituent elements are only tin, cobalt and carbon. In addition to tin, cobalt and carbon, the SnCoC-containing material may additionally contain, for example, at least one element selected from silicon (Si), iron (Fe), nickel (Ni), chromium (Cr), indium (In), niobium (Nb), germanium (Ge), titanium (Ti), molybdenum (Mo), aluminum (Al), phosphorus (P), gallium (Ga), bismuth (Bi) and the like as the constituent element thereof.

In addition to the Sn—Co—C-containing material, a material that contains tin, cobalt, iron and carbon as the constituent elements thereof (wherein the material is referred to as an “Sn—Co—Fe—C-containing material”, hereinafter) is also preferred. The composition of the Sn—Co—Fe—C-containing material may be any one. As one example, in the case where it is intended to set the content of iron to a smaller amount, the content of carbon is 9.9 to 29.7% by mass, the content of iron is 0.3 to 5.9% by mass, and the content ratio between tin and cobalt (which is represented by the formula: Co/(Sn+Co)) is 30 to 70% by mass. In the case where it is intended to set the content of iron to a larger amount, the content of carbon is 11.9 to 29.7% by mass, the content ratio between tin, cobalt and iron (which is represented by the formula: (Co+Fe)/(Sn+Co+Fe)) is 26.4 to 48.5% by mass, and the content ratio between cobalt and iron (which is represented by the formula: Co/(Co+Fe)) is 9.9 to 79.5% by mass. This is because a high energy density can be achieved when the composition falls within the above-mentioned ranges. The physical properties (e.g., a half bandwidth) of the Sn—Co—Fe—C-containing material are the same as those of the Sn—Co—C-containing material.

Specific examples of another negative electrode active material include: a metal oxide such as iron oxide, ruthenium oxide, molybdenum oxide, manganese dioxide (MnO₂) and vanadium oxide (V₂O₅, V₆O₁₃); a sulfide such as nickel sulfide (NiS) and molybdenum sulfide (MoS); a lithium nitride such as LiN₃; and a polymeric compound such as polyacetylene, polyaniline and polypyrrole.

Particularly, it is preferred that the negative electrode active material contains both of a carbon material and a metal-based material for the following reason. A metal-based material, particularly a material containing at least one of silicon and tin as the constituent element thereof has such an advantage that the material has a high theoretical capacity, but is likely to vigorously expand/shrink during charging and discharging. On the other hand, a carbon material has a low theoretical capacity, but has such an advantage that the carbon material is less likely to expand/shrink during charging and discharging. Therefore, when both of a carbon material and a metal-based material are used, the expansion/shrinkage during charging and discharging can be reduced while achieving a high theoretical capacity (i.e., a high battery capacity).

Specific examples of the positive electrode binder and the negative electrode binder include: a synthetic rubber such as a styrene butadiene-based rubber (e.g., styrene butadiene rubber (SBR)), a fluorine-based rubber, and ethylene propylene diene; a fluorine-based resin such as polyvinylidene fluoride (PVdF), polyvinyl fluoride, polyimide, polytetrafluoroethylene (PTFE) and ethylene tetrafluoroethylene (ETFE), and a copolymer or a modified product of the fluorine-based resin; a polyolefin-based resin such as polyethylene and polypropylene; an acrylic resin such as polyacrylonitrile (PAN) and a polyacrylic acid ester; and a polymeric material such as carboxy methyl cellulose (CMC), and also include at least one material selected from copolymers each mainly composed of any one of these resin materials and others. More specific examples of the copolymer of polyvinylidene fluoride include a (polyvinylidene fluoride)-hexafluoropropylene copolymer, a (polyvinylidene fluoride)-tetrafluoroethylene copolymer, a (polyvinylidene fluoride)-chlorotrifluoroethylene copolymer and a (polyvinylidene fluoride)-hexafluoropropylene-tetrafluoroethylene copolymer. As the positive electrode binder or the negative electrode binder, a conductive polymer may be used. As the conductive polymer, substituted or unsubstituted polyaniline, polypyrrole, polythiophene, a (co)polymer composed of one or two components selected from these compounds, and the like can be used.

Specific examples of the positive electrode conductive agent and the negative electrode conductive agent include carbon materials such as graphite, a carbon fiber, carbon black, a carbon nanotube, graphite, a vapor growth carbon fiber (VGCF), acethylene black (AB) and Ketjen black (KB), and these compounds may be used singly or two or more of them may be used in the form of a mixture. A specific example of the carbon nanotube is a single-wall carbon nanotube (SWCNT) or a multi-wall carbon nanotube (MWCNT) such as a double-wall carbon nanotube (DWCNT). Alternatively, a metallic material, a conductive polymeric material or the like can be used, as long as the material has electrical conductivity.

The positive electrode mix layer or the negative electrode mix layer can be formed by, for example, a coating method. Namely, the positive electrode mix layer or the negative electrode mix layer can be formed by a method (e.g., a coating method using a spray) in which a particulate (powdery) positive electrode active material or negative electrode active material is mixed with a positive electrode binder, a negative electrode binder or the like, then the resultant mixture is dispersed in a solvent such as an organic solvent, and then the resultant dispersion is applied onto a positive electrode current collector or a negative electrode current collector. The coating method is not limited to this method, and the method for the formation of the positive electrode mix layer or the negative electrode mix layer is not limited to the coating method. For example, a negative electrode member can be produced by molding a negative electrode active material, and a positive electrode member can be produced by molding a positive electrode active material. For the molding, a pressing machine or the like may be used. Alternatively, the electrode member can also be formed by a vapor phase method, a liquid phase method, a thermal spraying method or a firing method (sintering method). Examples of the vapor phase method include, a physical vapor deposition (PVD) method including a vacuum deposition method, a sputtering method, an ion plating method and a laser ablation method; and a chemical vapor deposition (CVD) method including a plasma CVD method. Examples of the liquid phase method include an electrolytic plating method and an electroless plating method. Thermal spraying method is a method in which a positive electrode active material or a negative electrode active material which is in a molten or half-molten state is sprayed onto a positive electrode current collector or a negative electrode current collector. The firing method is, for example, a method in which a mixture dispersed in a solvent is applied onto a negative electrode current collector by a coating method and then the mixture is heat-treated at a temperature higher than the melting point of the negative electrode binder or the like, and examples of the firing method include an atmospheric firing method, a reaction firing method and a hot-press firing method.

In order to prevent accidental deposition of lithium onto the negative electrode member during charging, it is preferred that the chargeable capacity of the negative electrode member is larger than the discharge capacity of the positive electrode member. Namely, it is preferred that the electrochemical equivalent of the negative electrode member that can store/release lithium is larger than that of the positive electrode member. In this regard, lithium deposited on the negative electrode member is, for example, metal lithium in the case where the electrode reaction product is lithium.

The electrolyte salt includes at least one lithium salt. Specific examples of the lithium salt that constitutes the non-aqueous electrolyte solution suitable for the use in a lithium ion secondary battery include, but are not limited to, LiPF₆, LiClO₄, LiBF₄, LiAsF₆, LiSbF₆, LiTaF₆, LiNbF₆, LiAlCl₄, LiSiF₆, LiCF₃SO₃, LiN(SO₂CF₃)₂, LiN(CₙF₂ₙ₊₁SO₂)₂, LiC(SO₂CF₃)₃, LiB(C₆H₅)₄, LiCH₃SO₃, LiN(CF₃SO₂)₂, LiC(CF₃SO₂)₃, LiC₄F₉SO₃, Li(FSO₂)_{2N} (also known as “LiFSI”), Li(CF₃SO₂)₂N, Li(C₂F₅SO₂)₂N, Li(CF₃SO₂)₃C, LiBF₃(C₂F₅), LiB(C₂O₄)₂, LiB(C₆F₅)₄, LiPF₃(C₂F₅)₃, ½Li₂B₁₂F₁₂, Li₂SiF₆, LiCl, LiBr, LiI, lithium difluoro[oxolato-O,O′]borate and lithium bisoxalateborate.

As the organic solvent (non-aqueous solvent), a cyclic carbonic acid ester such as ethylene carbonate (EC), propylene carbonate (PC) and butylene carbonate (BC) can be used. Among these solvents, ethylene carbonate (EC) or propylene carbonate (PC) can be used preferably, or a mixture of both of the solvents can be used more preferably, because cycle properties can be improved. Alternatively, as the solvent, a mixture of the cyclic carbonic acid ester and a linear carbonic acid ester such as diethyl carbonate, dimethyl carbonate, ethyl methyl carbonate and methyl propyl carbonate can also be used from the viewpoint of the achievement of high ion conductivity. Alternatively, the solvent may contain 2,4-difluoroanisole or vinylene carbonate. 2,4-Difluoroanisole can improve discharge capacity, and vinylene carbonate can improve cycle properties. A mixture of these compounds is preferably used, because both of discharge capacity and cycle properties can be improved.

Specific examples of the organic solvent (non-aqueous solvent) also include: a linear carbonic acid ester such as dimethyl carbonate (DMC), ethyl methyl carbonate (EMC), diethyl carbonate (DEC), dipropyl carbonate (DPC), propyl methyl carbonate (PMC), propyl ethyl carbonate (PEC) and fluoroethylene carbonate (FEC); a cyclic ether such as tetrahydrofuran (THF), 2-methyltetrahydrofuran (2-MeTHF), 1,3-dioxolane (DOL) and 4-methyl-1,3-dioxolane (4-MeDOL); a linear ether such as 1,2-dimethoxyethane (DME) and 1,2-diethoxyethane (DEE); a cyclic ester such as γ-butyrolactone (GBL) and γ-valerolactone (GVL); and a linear ester such as methyl acetate, ethyl acetate, propyl acetate, methyl formate, ethyl formate, propyl formate, methyl butyrate, methyl propionate, ethyl propionate and propyl propionate. Specific examples of the organic solvent (non-aqueous solvent) also include tetrahydropyran, 1,3-dioxane, 1,4-dioxane, N,N-dimethylformamide (DMF), N,N-dimethylacetamide (DMA), N-methyl-2-pyrrolidone (N-methylpyrrolidinone, NMP), N-methyloxazolidinone (NMO), N,N′-dimethylimidazolidinone (DMI), dimethylsulfoxide (DMSO), trimethyl phosphate (TMP), nitromethane (NM), nitroethane (NE), sulfolane (SL), methylsulfolane, acetonitrile (AN), succinonitrile (SN), anisole, propionitrile, glutaronitrile (GLN), adiponitrile (ADN), methoxyacetonitrile (MAN), 3-methoxypropionitrile (MPN), diethyl ether, butylene carbonate, 3-methoxypropironitrile, N,N-dimethylformamide, dimethyl sulfoxide, trimethyl phosphate, triethyl phosphate, ethylene sulfide and propane sultone. Alternatively, an ionic liquid can also be used. As the ionic liquid, any known ionic liquid can be used, and the ionic liquid may be selected as required. Among these solvents, a mixture of at least two solvents selected from the group consisting of fluoroethylene carbonate, ethylene carbonate, propylene carbonate, vinylene carbonate, diethyl carbonate, dimethyl carbonate and ethyl methyl carbonate can be used preferably, because excellent charge-discharge capacity properties and charge-discharge cycle properties can be achieved.

Specific examples of the polymeric compound for carrying use include polyacrylonitrile, polyvinylidene fluoride, polytetrafluoroethylene, polyhexafluoropropylene, polyethylene oxide, polypropylene oxide, polyphosphazene, polysiloxane, polyvinyl fluoride (PVF), polychlorotrifluoroethylene (PCTFE), perfluoroalkoxy fluororesin (PFA), an (ethylene tetrafluoride)-(propylene hexafluoride) copolymer (FEP), an ethylene-(ethylene tetrafluoride) copolymer (ETFE), an ethylene-chlorotrifluoroethylene copolymer (ECTFE), polyvinyl acetate, polyvinyl alcohol, polymethyl methacrylate, polyacrylic acid, polymethacrylic acid, a styrene-butadiene rubber, a nitrile-butadiene rubber, polystyrene, polycarbonate and vinyl chloride. These compounds may be used singly, or two or more of them may be used in the form of a mixture. Alternatively, the polymeric compound for carrying use may be a copolymer. A specific example of the copolymer is a (polyvinylidene fluoride)-hexafluoropropylene copolymer. Particularly from the viewpoint of electrochemical stability, the homopolymer is preferably polyvinylidene fluoride, polyacrylonitrile, polyhexafluoropropylene or polyethylene oxide, and the copolymer is preferably a (polyvinylidene fluoride)-hexafluoropropylene copolymer. It is also possible to contain Al₂O₃, SiO₂, TiO₂ or BN (a compound having high heat resistance, such as boron nitride) as a filler.

The device (electronic device or electric device) according to the present disclosure is provided with the above-mentioned battery according to the present disclosure or the like. The wearable device according to the present disclosure is provided with the above-mentioned battery according to the present disclosure or the like, and the IC card according to the present disclosure is provided with the above-mentioned battery according to the present disclosure or the like.

Examples of the electric device (electronic device) according to the present disclosure which is provided with the battery according to the present disclosure or the like (e.g., a lithium ion secondary battery) include, a note-type personal computer, a tablet-type computer, a battery pack used in a personal computer or the like as a removable power supply, various display devices, a PDA (Personal Digital Assistant, a mobile information terminal), a remote controller, a mobile phone, a smartphone, a main phone or a codeless handset for a codeless phone, a video movie (e.g., a video camera, a cam corder), a digital still camera, an electronic paper such as an electronic book and an electronic newspaper, an electronic dictionary, a music player, a mobile music player, a radio, a portable radio, a headphone, a headphone stereo, a game machine, various wearable devices which are so configured as to be freely removable from human bodies (e.g., a band-type electronic device such as a smart watch, a wristband, smart eyeglasses and a smart band, a wrist watch-type terminal, a bracelet-type electronic device, an eyeglasses-type electronic device such as a heat-mount display, a shoes-type electronic device, or a cloth-type electronic device, a medical device, a healthcare device or the like), a navigation system a memory card, an IC card, an artificial cardiac pacemaker, a hearing aid, a toy and a robot. The battery according to the present disclosure or the like (more specifically, a lithium ion secondary battery) can also be used as a driving power supply or an auxiliary power supply for an electric power tool, an electric shaver, a refrigerator, an air conditioner, a television receiver, a stereo, a water heater, a microwave oven, a dishwasher, a laundry, a drier machine, a lighting device including a room light, various electric devices (including portable electronic devices), a road conditioner, a traffic signal, a rail vehicle, a golf cart, an electrical cart and an electric vehicle (including a hybrid car). Alternatively, the battery according to the present disclosure or the like can also be installed in a construction product such as a house, a power supply for electric power storage purpose for use in a power generation plant or the like, or can also be used for supplying an electric power to the construction product, the power supply or the like. In an electric vehicle, the conversion device which can receive the supply of an electric power and can convert the electric power to a driving force is usually a motor. The control device (control unit) for performing an information processing relating to the control of a vehicle includes, for example, a control device which can perform the display of a remaining battery level on the basis of the information relating to the remaining battery level. The battery can also be used in an electrical storage device in a so-called smart grid. The electrical storage device of this type can supply an electric power, and can also receive the supply of electric power from other electric power source and can store the electric power. As the “other electric power source”, a thermal power generation, a nuclear power generation, a hydroelectric power generation, a solar cell, a wind power generation, a geothermal power generation, a fuel cell (including a biofuel cell) or the like can be used.

The battery according to the present disclosure or the like which includes the above-mentioned various preferred forms and configurations can be applied to a battery and a battery in a battery pack that is equipped with a control means (control unit) for performing control relating to a battery. In the battery pack, the control means (control unit) performs, for example, the control of charging and discharging, overdischarging or overcharging relating to the battery.

The battery according to the present disclosure or the like which includes the above-mentioned various preferred forms and configurations can be applied to a battery in an electronic device that can receive the supply of an electric power from the battery.

The battery according to the present disclosure or the like which includes the above-mentioned various preferred forms and configurations can be applied to a conversion device which can receive the supply of an electric power from a battery and can covert the electric power to a driving force for a vehicle, and can also be applied to a battery in an electric vehicle equipped with a control device (control unit) for performing an information processing relating to the control of a vehicle on the basis of information relating to the battery. In the electric vehicle, the conversion device typically receives the supply of an electric power from a battery to drive a motor, thereby generating a driving force. For driving the motor, a regenerative energy can be utilized. The control device (control unit) performs an information processing relating to the control of a vehicle on the basis of the remaining battery level of the battery. Examples of the electric vehicle include an electric vehicle, an electric motorcycle, an electric bicycle and a rail vehicle, and also include a so-called hybrid car.

The battery according to the present disclosure or the like which includes the above-mentioned various preferred forms and configurations can be applied to a battery in an electric power system that is so configured as to receive the supply of an electric power from the battery and/or supplies the electric power from an electric power source to the battery. The electric power system may be any one as long as the system utilizes an electric power, and includes a simple electric power system. Examples of the electric power system include a smart grid, a home energy management system (HEMS) and a vehicle, and the electric power system can store electricity.

The battery according to the present disclosure or the like which includes the above-mentioned various preferred forms and configurations can be applied to a battery in a power supply for electric power storage purposes which is equipped with the battery and is so configured as to be connected to an electronic device to which an electric power is to be supplied. The use application of the power supply for electric power storage purposes is not particularly limited, and can be used basically in any electric power system or electric power device, such as a smart grid.

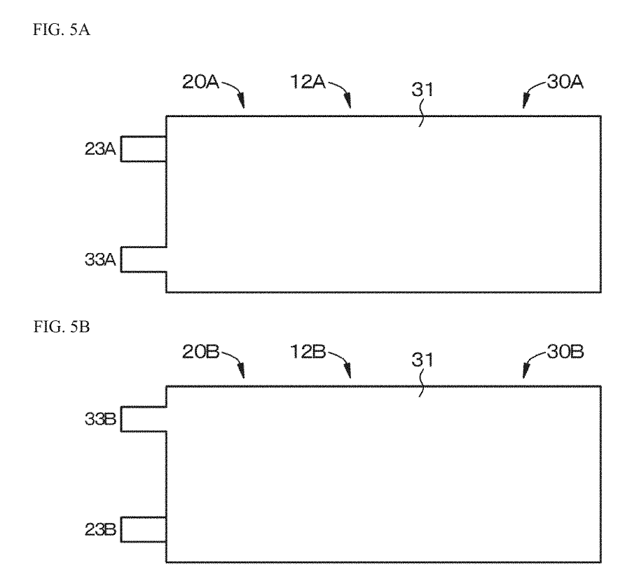

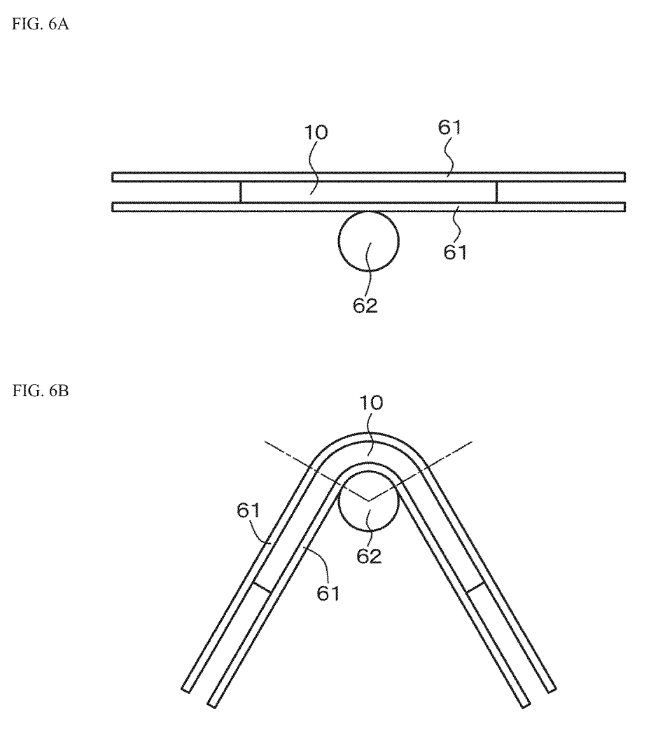

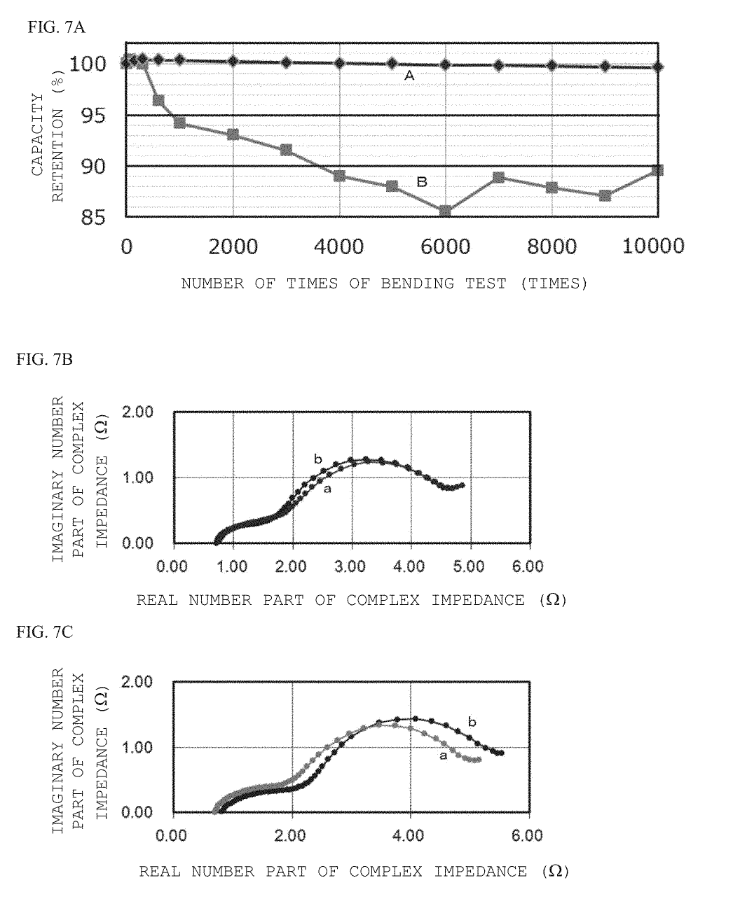

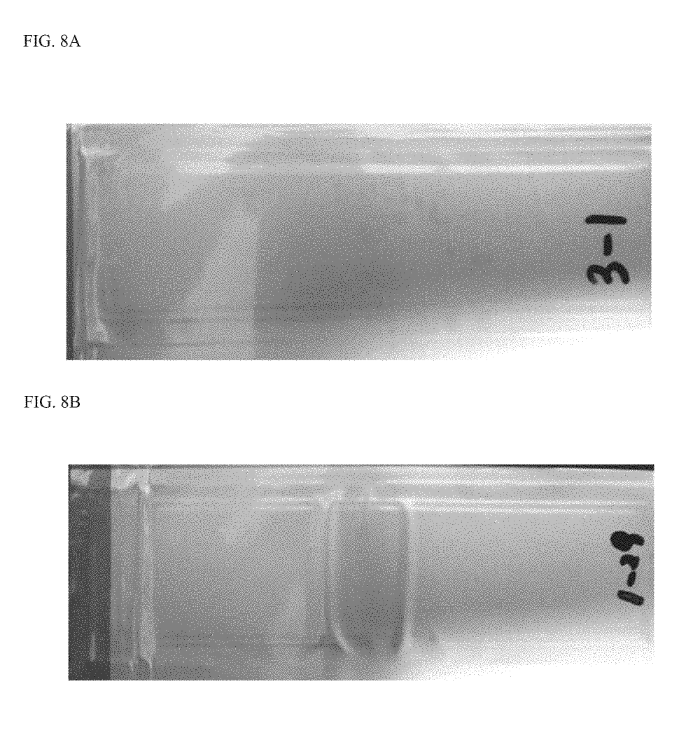

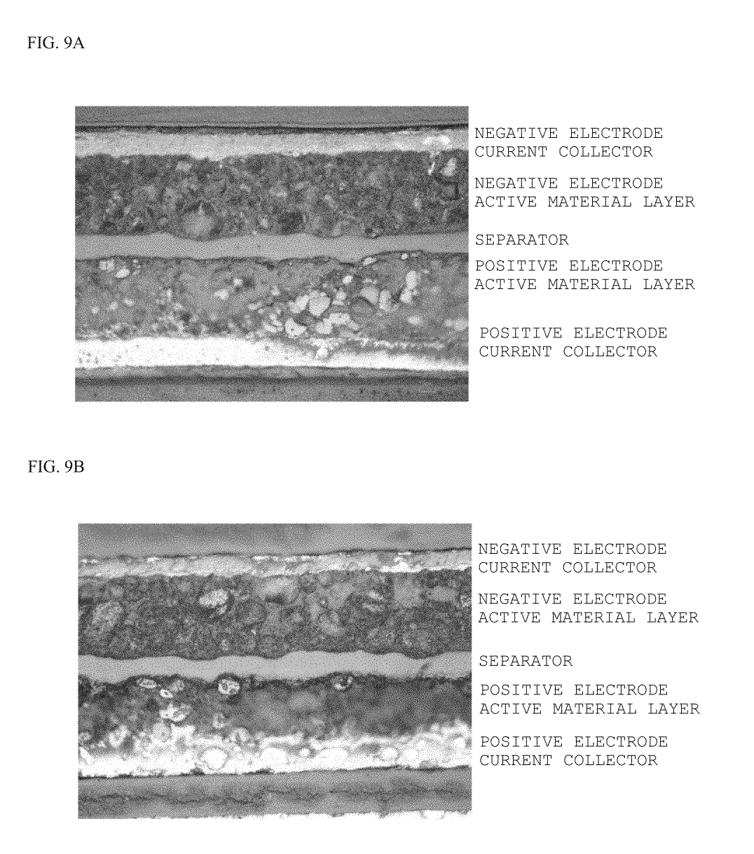

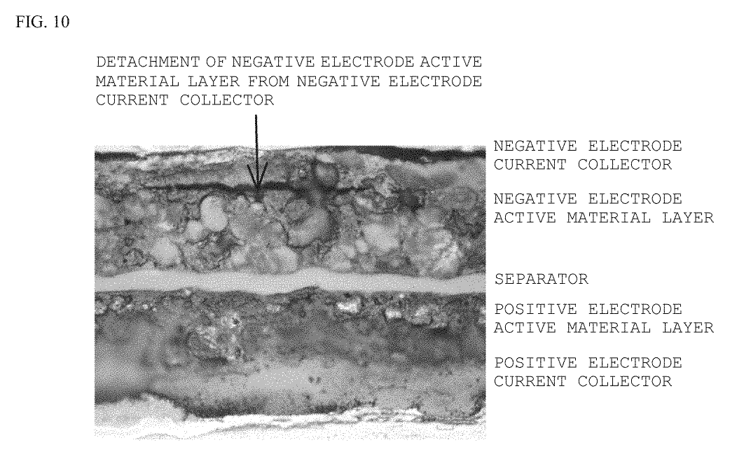

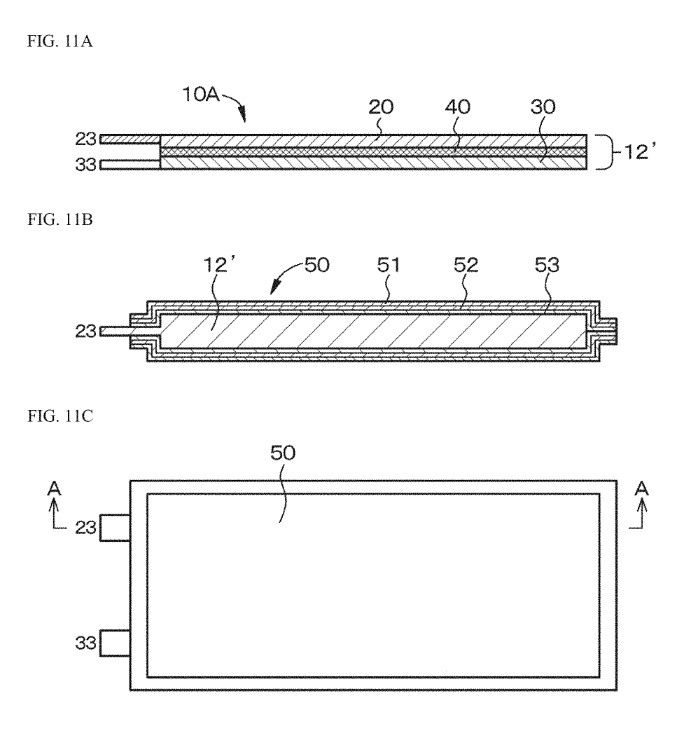

Example 1 relates to a battery according to the first aspect of the present disclosure. More specifically, the battery of Example 1 includes a lithium ion secondary battery. The schematic cross-sectional view of a multilayer structure constituting the battery of Example 1 is shown in FIG. 1A, the schematic cross-sectional view of the multilayer member constituting the battery of Example 1 is shown in FIG. 1B, the schematic cross-sectional view of the battery of Example 1 is shown in FIG. 1C, the schematic exploded perspective view of the battery of Example 1 is shown in FIG. 2, and the schematic plan view of the battery of Example 1 is shown in FIG. 1D. The schematic plan view of a positive electrode member constituting the battery of Example 1 is shown in FIG. 3A and FIG. 3B, the schematic plan view of a negative electrode member constituting the battery of Example 1 is shown in FIG. 4A and FIG. 4B, and the schematic plan view of the multilayer member is shown in FIG. 5. The schematic cross-sectional view shown in FIG. 1C is a schematic cross-sectional view taken along arrow A-A in FIG. 1D. In FIG. 1A, the multilayer members are shown in a separated state. Actually, however, the multilayer members are in contact with each other. In FIG. 2 and FIG. 23 mentioned below, only one multilayer member 12A is shown.

The battery 10 of Example 1 is provided with a multilayer structure 11 including a plurality of multilayer members 12 and an external packaging member 50 which covers (seals) the multilayer structure 11,

wherein:

each of the multilayer members 12 includes
a positive electrode member 20 provided with a positive electrode current collector 21 and a positive electrode mix layer 22 formed on one surface of the positive electrode current collector 21,
an electrolyte-containing separator 40, and
a negative electrode member 30 provided with a negative electrode current collector 31 and a negative electrode mix layer 32 formed on one surface of the negative electrode current collector 31;

the positive electrode member 20, the separator 40 and the negative electrode member 30 are laminated together and are arranged in such a manner that the positive electrode mix layer 22 and the negative electrode mix layer 32 can face each other;

the multilayer members 12 are stacked on each other in such a manner that the current collectors having the same polarity (e.g., the positive electrode current collector 21 and the positive electrode current collector 21, the negative electrode current collector 31 and the negative electrode current collector 31) can face each other; and

the external packaging member 50 is provided with at least a resin layer 51 having a Young's modulus of 3*10⁹ Pa or more, preferably 4×10⁹ Pa or more.

In the battery 10 of Example 1, the electrolyte has a gel-like or solid form. The external packaging member 50 includes a resin layer (surface protection layer) 51, an intermediate layer (moisture-proof layer, barrier layer) 52 and a heat-sealable material layer (melting layer, melting layer) 53 which are laminated in this order as observed from the outside of the external packaging member. The resin layer 51 contains, for example, a polyester-based resin, concretely a polyethylene terephthalate resin (PET resin) or the like. The intermediate layer 52 includes an aluminum foil, and the heat-sealable material layer includes a biaxially stretched polypropylene (CPP) film. Furthermore, in the multilayer structure 11, the multilayer members 12 are connected in parallel with each other. When the multilayer members 12 are connected in parallel with each other, even if variation in characteristics occurs among the multilayer members 12 in association with the bending, curling or the like of the battery, it becomes possible to prevent the deterioration of the whole body of the multilayer structure and it also becomes possible to provide a battery having high safety and flexibility and has resistance to bending. In Example 1, the external packaging member 50 is composed of a first external packaging member 50A and a second external packaging member 50B, and the first external packaging member 50A and the second external packaging member 50B have the same size as each other and are overlaid on each other so as to sandwich the multilayer structure 11 therebetween. The first external packaging member 50A and the second external packaging member 50B, which are overlaid on each other, are fusion-bonded to each other at four sides thereof to form a fusion-bonded part 50′ at the peripheries of the first external packaging member 50A and the second external packaging member 50B.

The shape of the battery of Example 1 or a battery of Example 2 mentioned below has a flat-plate-like or sheet-like shape. The battery 10 of Example 1 has a rectangular shape as observed from the direction orthogonal to the main surface of the battery.

More specifically, the positive electrode current collector 21 is made from an aluminum foil having a thickness of 12 μm. The positive electrode mix layer 22 is composed of a positive electrode active material containing LiCoO₂ (LCO), a positive electrode conductive agent and a positive electrode binder (a (polyvinylidene fluoride)-hexafluoropropylene copolymer). The negative electrode current collector 31 is made from a copper foil having a thickness of 8 μm. The negative electrode mix layer 32 is composed of a graphite powder, a negative electrode conductive agent and a negative electrode binder (a (polyvinylidene fluoride)-hexafluoropropylene copolymer). The electrolyte salt in the gel-like electrolyte is composed of LiPF₆, and a (polyvinylidene fluoride)-hexafluoropropylene copolymer is used as the polymeric compound for carrying use. The separator 40 is composed of a porous polyethylene film.

Hereinafter, the summary of the method for producing the battery 10 of Example 1 will be described.

A positive electrode active material composed of LiCoO₂ (LCO) in an amount of 98.0% by mass, a positive electrode conductive agent composed of carbon black in an amount of 0.8% by mass, and a positive electrode binder (a (polyvinylidene fluoride)-hexafluoropropylene copolymer) in an amount of 1.2% by mass were mixed together to prepare a positive electrode mix, and then the positive electrode mix was dispersed in N-methyl-2-pyrrolidone (NMP) to prepare a slurry having a viscosity of about 10 Pa·s. Subsequently, the slurry was applied in a strip-like shape onto one surface of a positive electrode current collector 21 made from an aluminum foil having a thickness of 12 μm. The slurry was dried, and was then compression-molded with a roll pressing machine to integrate the positive electrode mix layer 22 to the positive electrode current collector 21. The positive electrode mix layer 22 was formed on the entire surface of the positive electrode current collector 21 excluding the overhanging part 23 that corresponded to a positive electrode lead part. In FIG. 3A and FIG. 3B, in order to illustrate the positive electrode mix layer 22 clearly, the positive electrode mix layer 22 was shown inside of the positive electrode current collector 21. A positive electrode member 20 thus produced was punched in a symmetric form with a die to produce a positive electrode member 20A and a positive electrode member 20B (see FIG. 3A and FIG. 3B). In the positive electrode current collector 21, overhanging parts 23 (23A, 23B) were provided as positive electrode lead parts. The overhanging parts 23 (23A, 23B) protruded in the same direction from one shorter side of the battery 10. Adhesive films 24 and 34 (shown only in FIG. 23) for preventing the invasion of outdoor air may be inserted between the external packaging member 50 and the overhanging part 23.

A graphite powder in an amount of 94.5% by mass which served as a negative electrode active material, a negative electrode conductive agent in an amount of 2.0% by mass which was made from of vapor growth carbon fibers, and a negative electrode binder (a (polyvinylidene fluoride)-hexafluoropropylene copolymer) in an amount of 3.5% by mass were mixed together to prepare a negative electrode mix, and then the negative electrode mix was dispersed in N-methyl-2-pyrrolidone to prepare a slurry having a viscosity of about 10 Pa·s. Subsequently, the slurry was applied in a strip-like shape onto one surface of a negative electrode current collector 31 made from a copper foil having a thickness of 8 μm. Subsequently, the slurry was dried and was then compression-molded with a roll pressing machine to integrate the negative electrode mix layer 32 to the negative electrode current collector 31. The negative electrode mix layer 32 is formed on the entire surface of the negative electrode current collector 31 excluding an overhanging part 33 that corresponds to a negative electrode lead part. In FIG. 4A and FIG. 4B, in order to show the negative electrode mix layer 32 clearly, the negative electrode mix layer 32 is shown inside of the negative electrode current collector 31. The negative electrode member 30 thus produced was punched symmetrically to produce a negative electrode member 30A and a negative electrode member 30B (see FIG. 4A and FIG. 4B). The negative electrode current collector 31 had overhanging parts 33 (33A, 33B) provided therein as negative electrode lead parts.

Into a solvent prepared by mixing 50 parts by mass of ethylene carbonate (EC) with 50 parts by mass of propylene carbonate (PC) was dissolved 1.0 mol/kg of LiPF₆ that served as an electrolyte salt. Subsequently, 10 parts by mass of a (polyvinylidene fluoride)-hexafluoropropylene copolymer was further mixed with the resultant dispersion. Then, dimethyl carbonate was mixed and dissolved to prepare an electrolyte solution.

Subsequently, the electrolyte solution was applied uniformly onto the surface of each of the positive electrode mix layer 22 in the positive electrode member and the negative electrode mix layer 32 in the negative electrode member to cause each of the positive electrode mix layer 22 and the negative electrode mix layer 32 to be impregnated with the electrolyte solution. Subsequently, the resultant product was allowed to leave at ambient temperature for 8 hours to vaporize and remove dimethyl carbonate. In this manner, a gel-like electrolyte was produced.

The positive electrode member 20A and the negative electrode member 30A, each of which was produced in the above-mentioned manner and was impregnated with the gel-like electrolyte, were arranged with a separator 40 composed of a 10 μm-thick porous polyethylene film interposed therebetween in such a manner that the position “A” shown in FIG. 3A and the position “C” shown in FIG. 4A were superimposed with each other, and then these electrode members were temporarily pressure-bonded, and were then thermally pressure-bonded together at 105° C. with a pressing machine to produce a multilayer member 12A shown in FIG. 5A. In the same manner, the positive electrode member 20B and the negative electrode member 30B, which were produced in the above-mentioned manner and were impregnated with the electrolyte solution, were arranged with a separator 40 made from a 10 μm-thick porous polyethylene film interposed therebetween in such a manner that the position “B” shown in FIG. 3B was superimposed with the position “D” shown in FIG. 4B, and then these electrode members were temporarily pressure-bonded together, and were then thermally pressure-bonded together at 105° C. with a pressing machine to produce a multilayer member 12B shown in FIG. 5B.

The multilayer member 12A, the multilayer member 12B, the multilayer member 12B and the multilayer member 12A thus produced were arranged in this order in such a manner that the positive electrode members face each other and the negative electrode members face each other. In this manner, the four multilayer members were stacked together. Subsequently, lead-out electrode parts (the overhanging parts 23, the overhanging parts 33) were bonded together with an ultrasonic welding machine to produce batteries which were electrically connected in parallel with each other (i.e., unassembled batteries).

As an external packaging member 50, an external packaging member was used, in which a resin layer 51 composed of a 50 μm-thick polyethylene terephthalate film (Young's modulus: 4.0 GPa), an intermediate layer 52 made from a 20 μm-thick aluminum foil and a heat-sealable material layer 53 composed of a 30 μm-thick biaxially stretched polypropylene (CPP) film were laminated. The unassembled batteries were covered with an external packaging member, and were sealed under a reduced pressure with a heat sealer (i.e., the heat-sealable material layers 53 were melt-adhered to each other) to produce the battery 10 of Example 1. An overhanging part 23 and an overhanging part 33 were overhung from the external packaging member.

Batteries were also produced using external packaging members each provided with each of various resin layers shown in Table 1 in place of the polyethylene terephthalate film that served as a resin layer.

A battery of Comparative Example 1A was produced in the same manner as in Example 1, except that the external packaging member was replaced by another one. Concretely, the battery of Comparative Example 1A was produced using an external packaging member made from a laminate of a 15 μm-thick resin layer made from oriented nylon (ON), a 30 μm-thick intermediate layer made from an aluminum foil, a 25 μm-thick heat-sealable material layer made from a biaxially stretched polypropylene (CPP) film.

A battery of Comparative Example 1B was produced by replacing the gel-like electrolyte in the battery of Example 1 by a non-aqueous electrolyte. Concretely, in the production of the battery of Comparative Example 1B, the step of impregnating with the gel-like electrolyte was omitted, and an electrolyte solution was prepared by dissolving 1.0 mol/kg of LiPF₆ in a mixed solvent composed of 30 parts by mass of ethylene carbonate (EC) and 70 parts by mass of diethylene carbonate.

TABLE 1
Example 1A: a polyethylene terephthalate film (Young's modulus:
4.0 GPa)
Example 1B: a polyethylene-2,6-naphthalate film (Young's modulus:
6.0 GPa)
Example 1C: a polyphenylene sulfide film (Young's modulus: 4.0 GPa)
Example 1D: a polyimide film (Young's modulus: 3.0 GPa)
Comparative Example 1A: oriented nylon (Young's modulus: 1.7 GPa)
Comparative Example 1B: a polyethylene terephthalate film (Young's
modulus: 4.0 GPa)

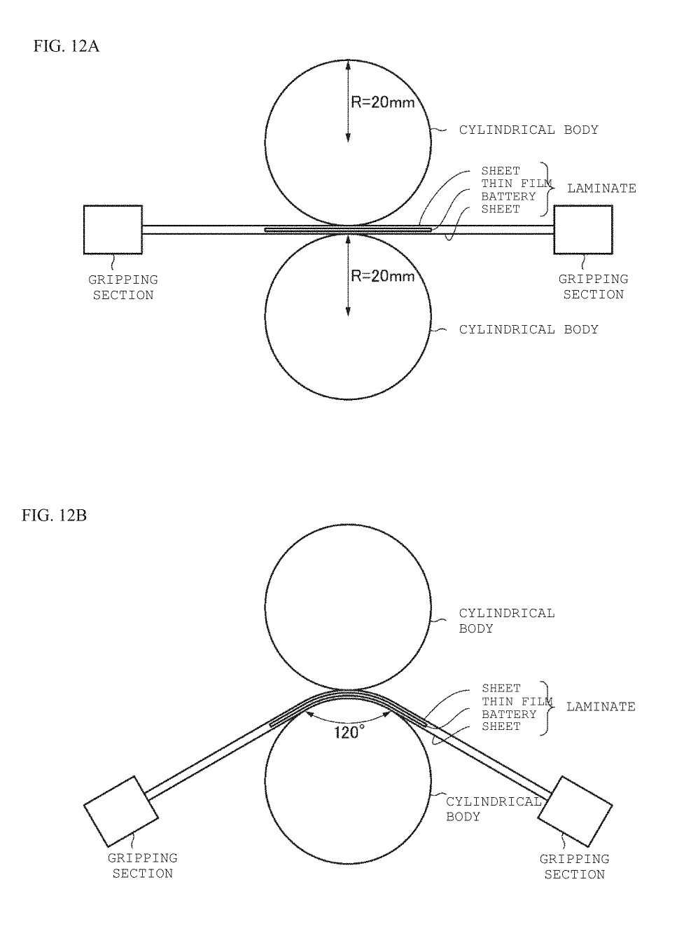

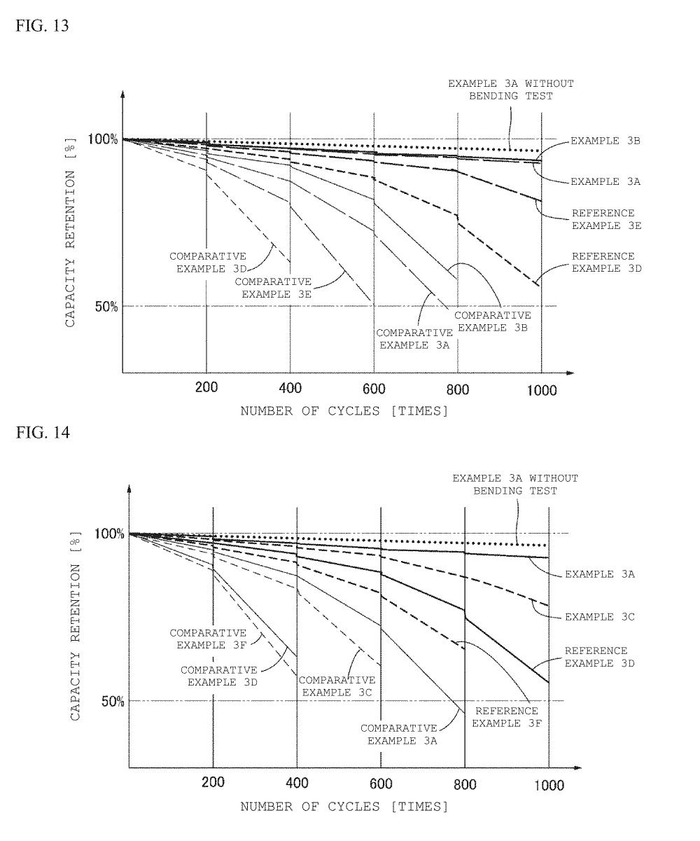

The battery was subjected to CC-CV charging to 4.2 volts at a current rate of 0.1 C, and was then subjected to CC discharging to 3.0 volts at a current rate of 0.1 C to measure an initial discharge capacity. Subsequently, a bending test was carried out 100,000 times, wherein 1 cycle of the bending test is as follows: the battery 10 of Example 1 that was in a flat state was sandwiched by support films 61 (see FIG. 6A), and was then pressed against a stainless steel bar 62 having a diameter of 20 mm at an angle of 120 degrees (see FIG. 6B) to bend and deform the sandwiched product, and then the bent product was returned to a flat state again. The appearance of the battery of Example 1 after the bending test was observed. Subsequently, charging and discharging were carried out under the same conditions as those employed for the initial charging and discharging procedure to measure a discharge capacity, and a percentage of discharge capacity retention after 100,000 times of bending was determined, wherein the initial discharge capacity was defined as 100. The results are shown in Table 2.

TABLE 2

| | | Results of observation of |
|---|---|---|
| | Discharge | appearance after bending |
| | capacity retention | test |
| Example 1A | 100 | with no change |
| Example 1B | 102 | with no change |
| Example 1C | 99 | with no change |
| Example 1D | 98 | with no change |
| Comparative | 57 | wrinkling occurred at |
| Example 1A | | center of curl |
| Comparative | 10 | Blistering occurred |
| Example 1B | | throughout battery |

From the results of the test, it was demonstrated that the batteries of Example 1A, Example 1B, Example 1C and Example 1D were highly resistant to bending and curling and had excellent flexibility.

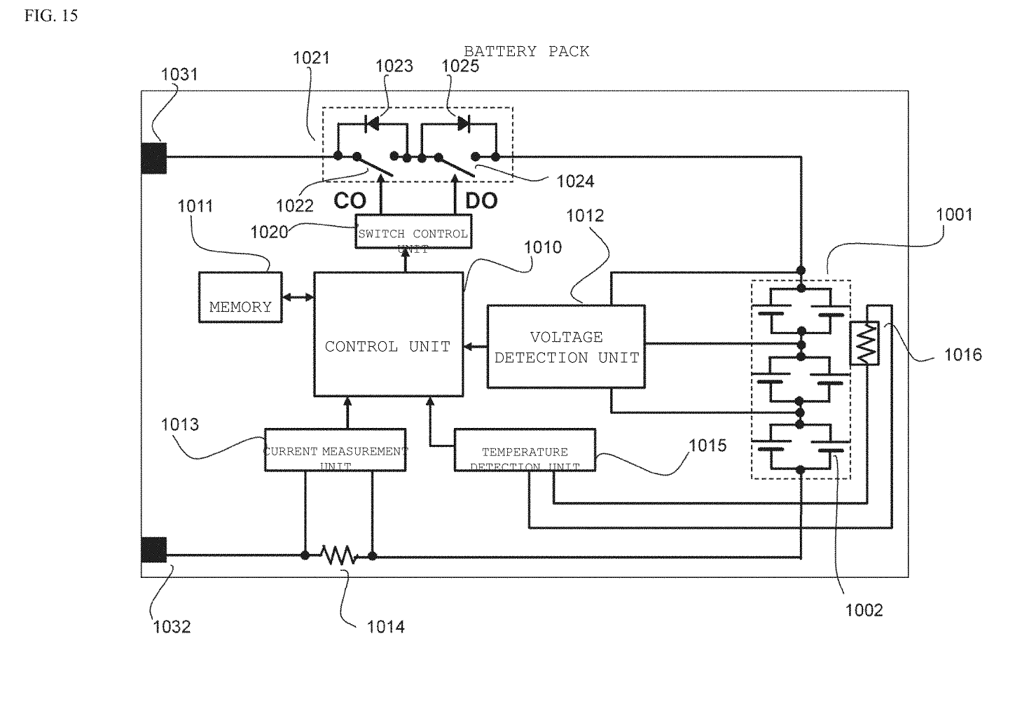

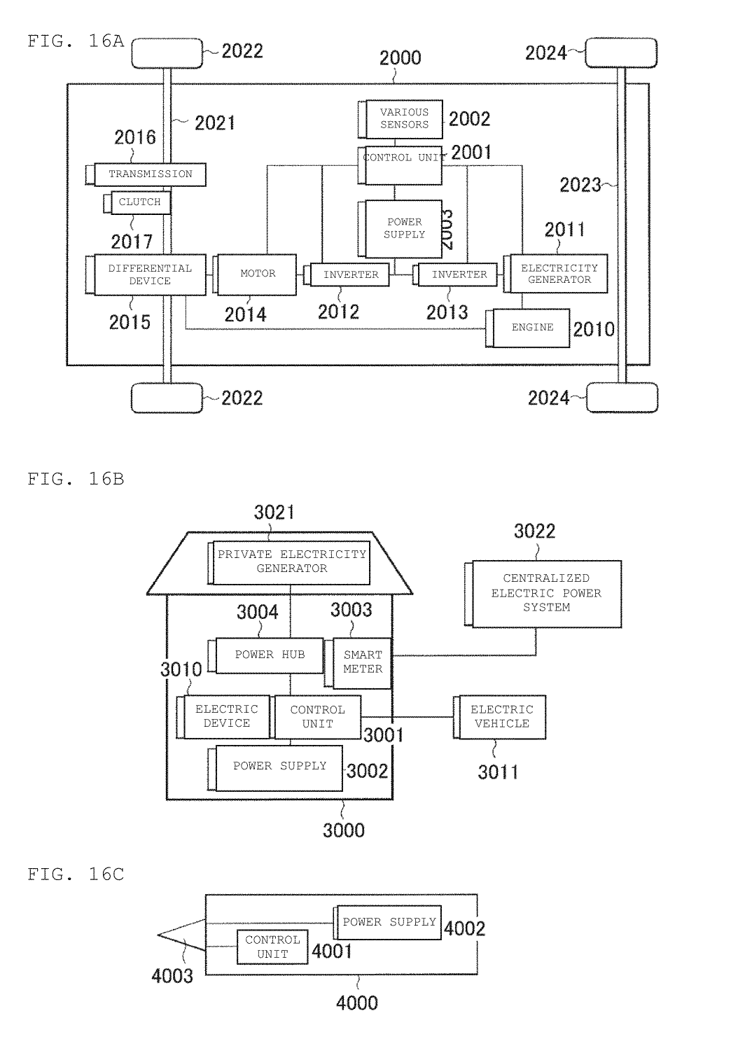

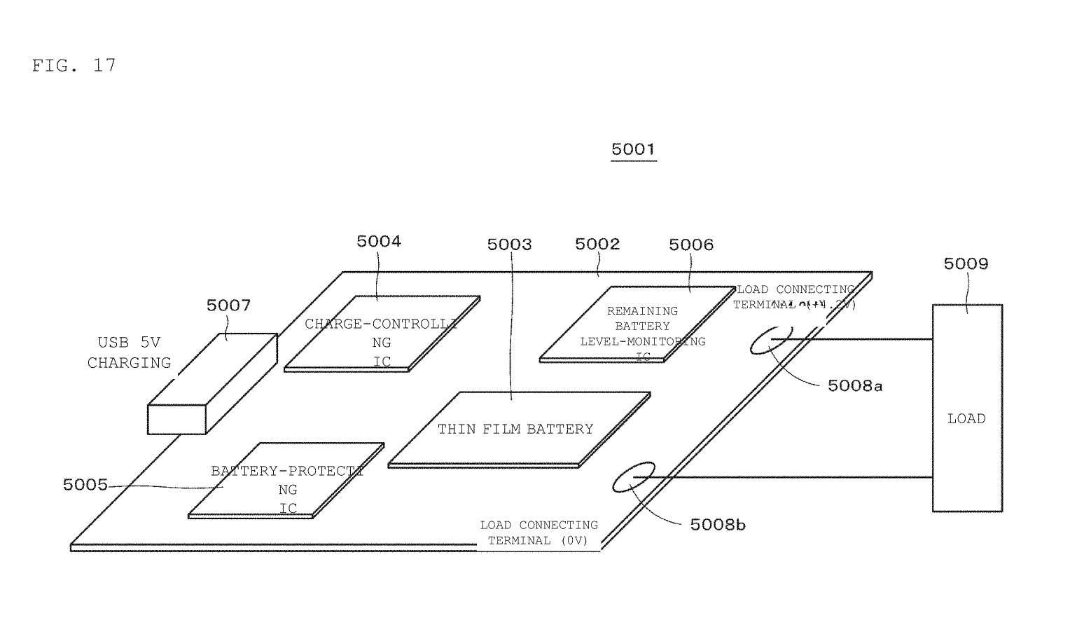

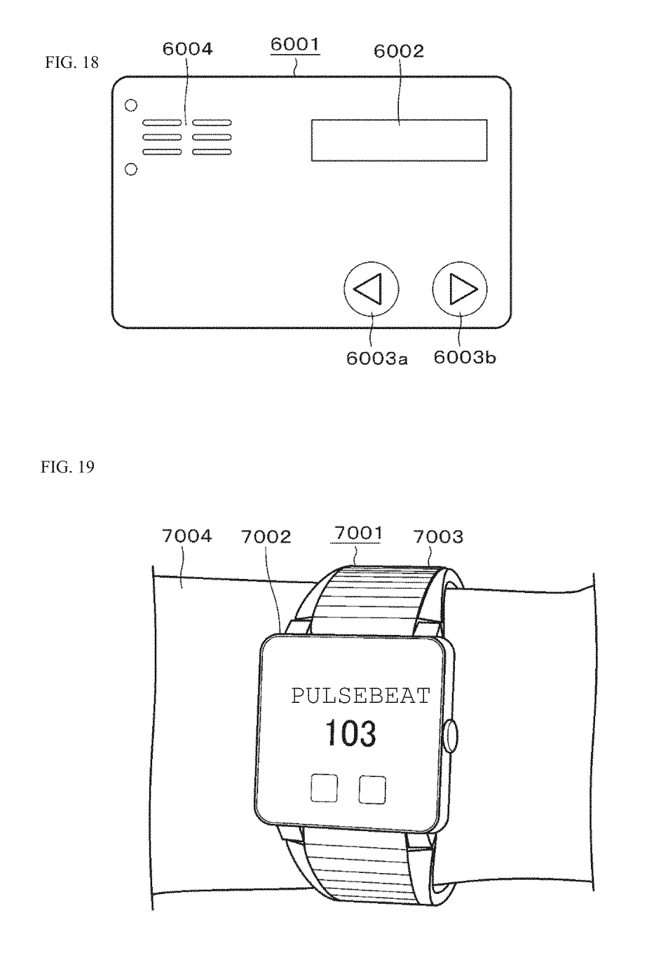

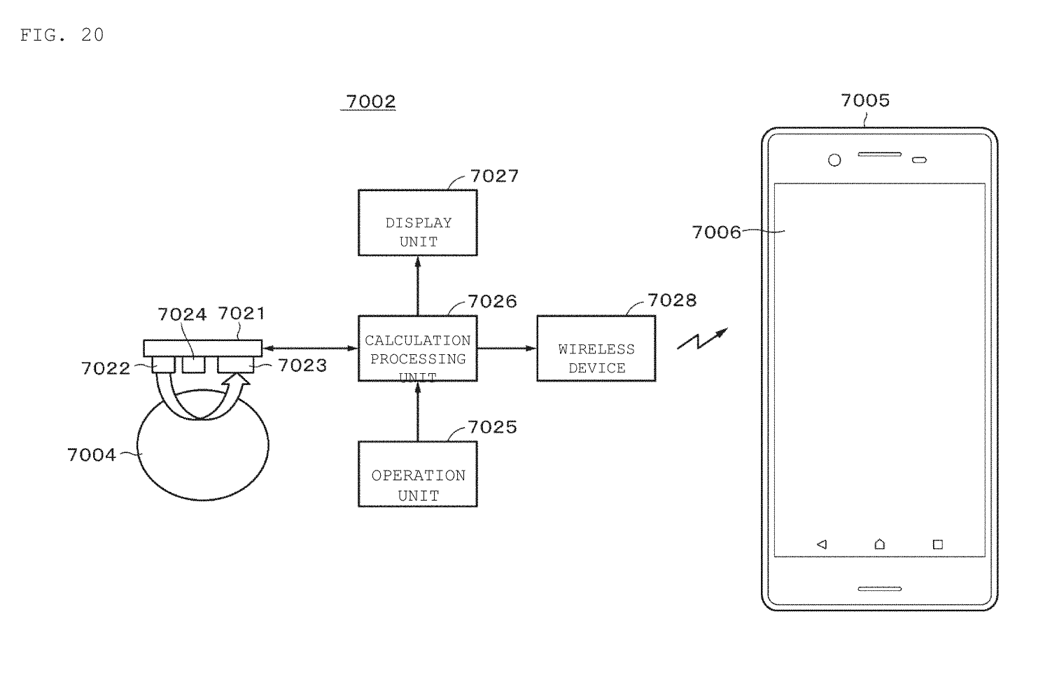

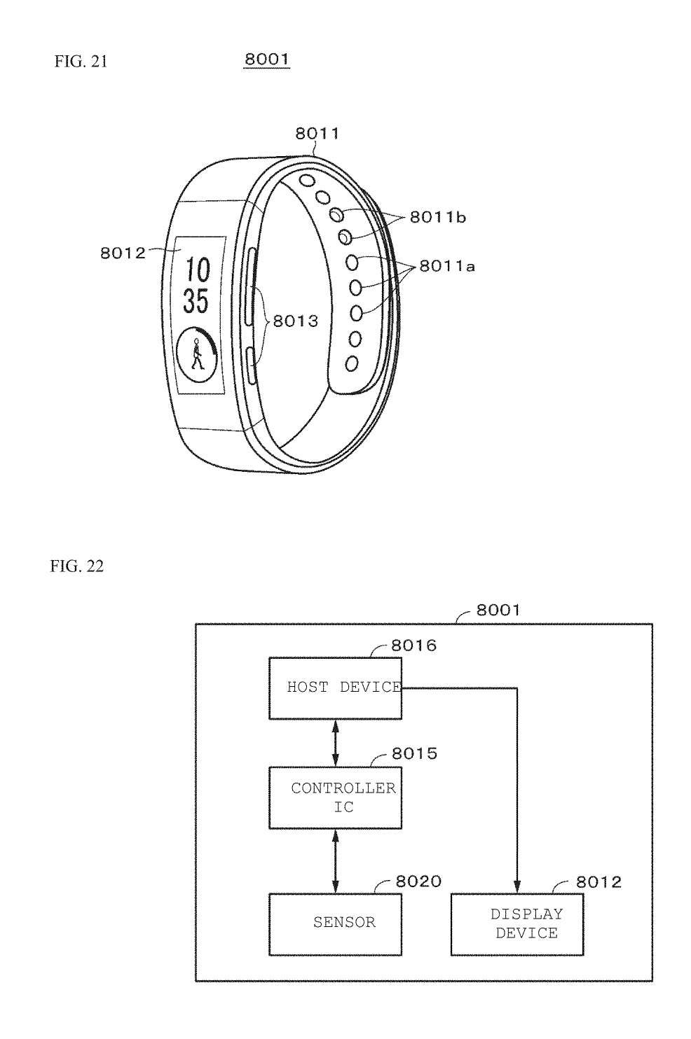

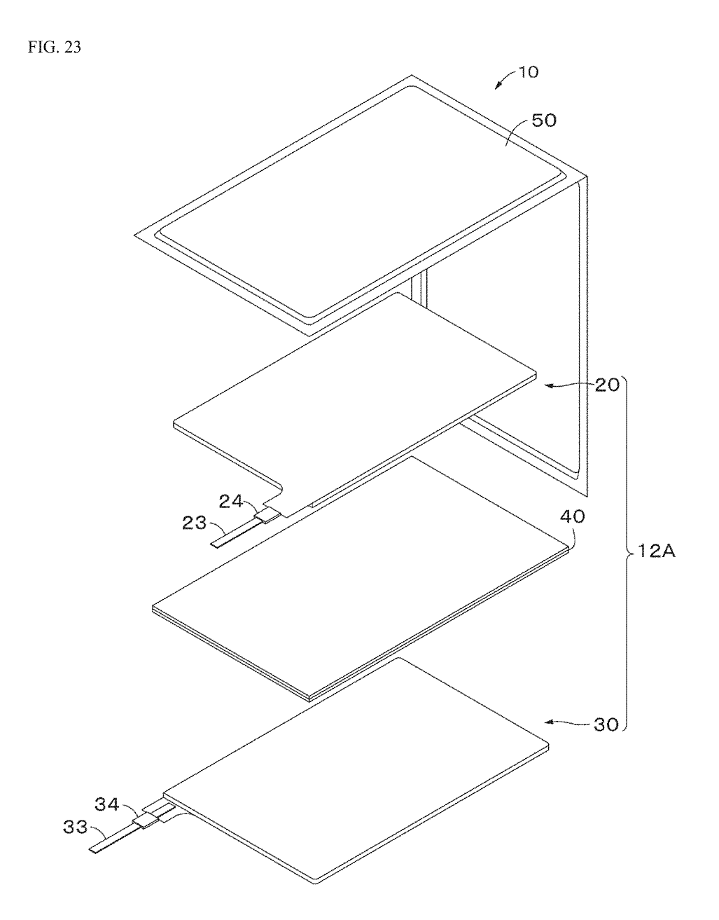

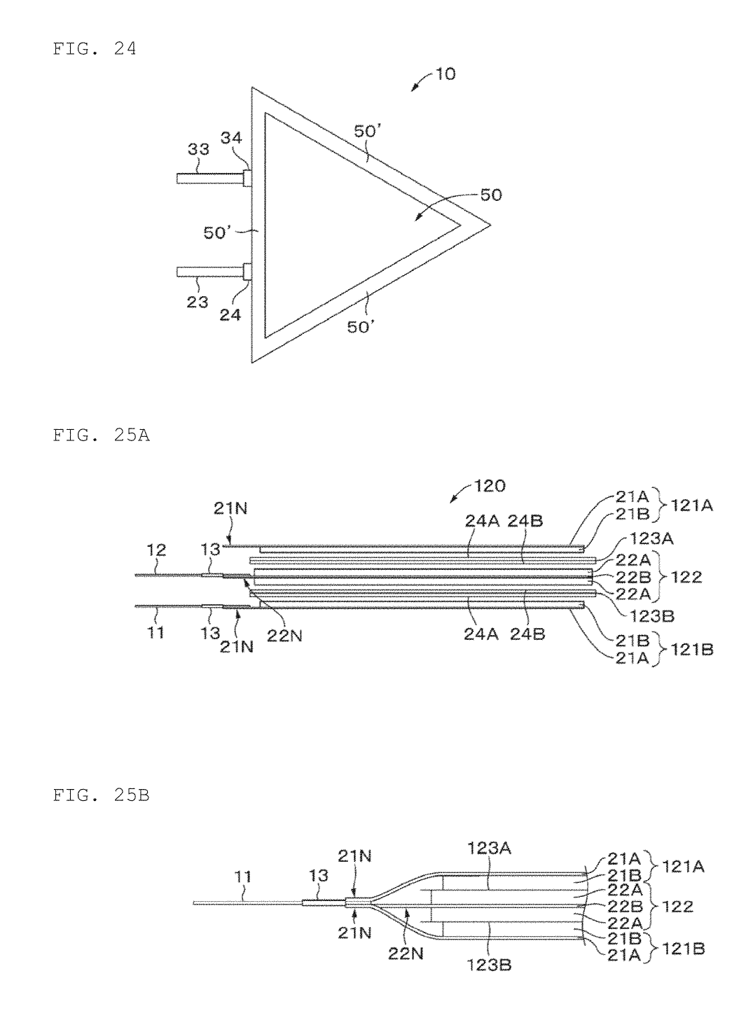

In FIG. 7A, the results obtained by subjecting the batteries of Example 1A and Comparative Example 1A to 10,000 times of the bending test are shown. In FIG. 7A, “A” shows the measurement results of Example 1A, “B” shows the measurement results of Comparative Example 1A, the transverse axis shows the number of times of the bending test (unit: time), and the vertical axis shows discharge capacity retention (unit: %). In FIG. 7B and FIG. 7C, the results of the measurement of impedance of the batteries of Example 1A and Comparative Example 1A after carrying out the bending test 4,000 times are shown. In FIG. 7B and FIG. 7C, “a” shows initial values, “b” shows the measurement results obtained after carrying out the bending test 4,000 times, the transverse axis shows the values of real number parts in complex impedances (unit: ohm), and the vertical axis shows the values of imaginary number parts in complex impedances (unit: ohm). From FIG. 7A, it is demonstrated that: in the batter of Example 1A, the capacity retention was nearly unchanged even after the bending test was carried out 10,000 times; while, in the battery of Comparative Example 1A, the capacity retention was largely decreased. From FIG. 7B and FIG. 7C, it is demonstrated that: in the battery of Example 1A, the impedance was nearly unchanged even after carrying out the bending test 4,000 times; while, in the battery of Comparative Example 1A, the impedance was increased. The photographs of the appearances of the batteries of Example 1A and Comparative Example 1A after the bending test are respectively shown in FIG. 8A and FIG. 8B. In the appearance of the battery of Example 1A, the occurrence of wrinkling was not observed. In the appearance of the battery of Comparative Example 1A, the occurrence of wrinkling was observed. Furthermore, the photograph of the cross section of the battery of Example 1A before the bending test is shown in FIG. 9A, and the photograph of the cross section of the battery of Example 1A after carrying out the bending test 10,000 times is shown in FIG. 9B. In these photographs, a large change was not observed between the cross sections of the battery. The photograph of the cross section of the battery of Comparative Example 1A after carrying out the bending test 10,000 times is shown in FIG. 10. In this photograph, it is demonstrated that the negative electrode active material was detached from the negative electrode current collector.

On the basis of the structure of the battery, the battery constituent materials which can undergo plastic deformation are roughly classified into two materials. One of the materials is a metal layer constituting the positive electrode current collector or the negative electrode current collector, and the other is a metal layer constituting the intermediate layer contained in the external packaging member. The battery of Example 1 can realize a battery in which the bending stress in these metal layers can be relaxed and which has high plasticity and flexibility.

Firstly, consideration will be given to the metal layer constituting each of the positive electrode current collector and the negative electrode current collector. In a lithium ion battery for example, an aluminum foil and a copper foil are used in the positive electrode current collector and the negative electrode current collector, respectively. These foils are metallic materials and may be plastically deformed upon the application of an excessive tensile force. In the multilayer member made from one layer for example, the expansion/shrinkage of the multilayer member can be expressed by the following formulae. In the formulae, the symbols represent as follows.

Lₒᵤₜ: the external length of a curled multilayer member

Lᵢₙ: the inner length of a curled multilayer member

L: the length of a flat multilayer member

T: the thickness of a multilayer member

θ: the curled angle of a multilayer member

θr: the radius of curvature (median value) of a curled multilayer member

Lₒᵤₜ=(r+T/2)×2π×(θ/2π)=(r+T/2)×θ

Lᵢₙ=(r−T/2)×2π×(θ/2π)=(r−T/2)×θ

Therefore, the outside of a curled multilayer member extends by (T×θ/2), and the inside of the curled multilayer member is shrunk by (T×θ/2). Because θ is L/r (θ=L/r), the following formulae are established:

Lₒᵤₜ=(r+T/2)×(L/r)

Lᵢₙ=(r−T/2)×(L/r)

In the formulae, r and L are fixed depending on the specification to be required for the battery. Therefore, in a battery in which multilayer members are laminate, a battery having high resistance to curling can be provided by reducing the thickness of the multilayer members.

From the above-mentioned formulae, it is demonstrated that the amount of elongation (deformation) caused by a tensile stress is proportional to the thickness T of the multilayer member. In other words, the tensile stress can be decreased by decreasing the thickness T of the multilayer member. Actually, however, in order to increase the energy density of the battery, the battery is often formed from a multilayer structure in which multilayer members are laminate. In this case, the thickness of the multilayer structure increases in the proportion to the number of the laminated multilayer members and therefore the amount of deformation upon being curled increases and the problem of occurrence of wrinkling may occur as mentioned above.

In the battery of Example 1, the positive electrode current collectors are stacked on each other in such a manner that the second surfaces respectively located on the outsides of the positive electrode current collectors face each other, or the negative electrode current collectors are stacked on each other in such a manner that the second surfaces respectively located on the outsides of the negative electrode current collectors face each other, so that the current collectors that are stacked in the multilayer structure are not fixed to each other. As a result, when the battery is curled, the second surfaces of the current collectors, which face each other, can move (slide) relative to each other. Accordingly, the stress applied to the multilayer structure as the result of the curling of the battery is substantially divided into a stress corresponding to a single layer of the multilayer member. In the battery of Example 1, since the electrolyte has a gel-like form, the positive electrode member and the negative electrode member are less likely to move relative to each other upon the curling of the battery. Furthermore, in the gel-like electrolyte, a process for injecting an electrolyte solution in vacuo is not needed and therefore a continuous application process can be employed. Therefore, it is considered that the use of a gel-like electrolyte is advantageous from the viewpoint of production efficiency in the production of a large-area lithium ion secondary battery.

With respect to the external packaging member, the external packaging member is arranged on the outermost side of the battery, and is a part which can be most easily influenced by deformation among the constituent members of the battery. An aluminum laminate film which is commonly used in a lithium ion secondary battery is mentioned as an example of the external packaging member. In most cases, the external packaging member has a three-layer structure composed of a resin layer, an intermediate layer and a sheet seal material later in this order as observed from the outside, and the multilayer structure is enclosed and sealed in the film. Conventionally, the outermost resin layer is often made from a resin material for the purpose of improving slidability, and an aluminum foil is used as the intermediate layer. The oriented nylon resin material has a Young's modulus of 2 GPa or less and therefore has a small elastic modulus, and has an easy-to-stretch property in order to facilitate the shaping by embossing or the like. When the material of this type comes in contact with the aluminum foil, the material cannot accept a force to stretch the aluminum foil. As a result, the aluminum foil is plastically deformed, and therefore the problem mentioned above occurs. For these reasons, in the battery of Example 1, the outermost layer of the external packaging member is formed from a resin layer having a Young's modulus of 3 GPa or more. When a resin layer having a Young's modulus of 3 GPa or more comes into contact with the intermediate layer composed of an aluminum foil, the aluminum foil cannot be plastically deformed easily, the occurrence of excessive deformation in the external packaging member can be prevented, and the problem as mentioned above can be prevented. As a result, a battery having high safety and flexibility and having high resistance to bending can be provided.

Example 2 relates to a battery according to the second aspect of the present disclosure. The schematic cross-sectional view of a multilayer member constituting the battery of Example 2 is shown in FIG. 11A, the schematic cross-sectional view of the battery of Example 2 is shown in FIG. 11B, and the schematic plan view of the battery of Example 2 is shown in FIG. 11C. The schematic cross-sectional view of FIG. 11B is a schematic cross-sectional view taken along arrows A-A in FIG. 11C.

The battery 10A according to Example 2 is provided with a multilayer member 12′ and an external packaging member 50 which covers (seals) the multilayer member 12′,

wherein:

the multilayer member 12′ includes
a positive electrode member 20 provided with a positive electrode current collector 21 and a positive electrode mix layer 22 formed on one surface of the positive electrode current collector 21,
an electrolyte-containing separator 40, and
a negative electrode member 30 provided with a negative electrode current collector 31 and a negative electrode mix layer 32 formed on one surface of the negative electrode current collector 31;

the positive electrode member 20, the separator 40 and the negative electrode member 30 are laminated together.

Namely, the battery 10A of Example 2 is composed of a single layer of the multilayer member 12′.

The electrolyte has a gel-like or solid form; and

the external packaging member 50 is provided with at least a resin layer 51 having a Young's modulus of 3×10⁹ Pa or more, preferably 4×10⁹ Pa or more.

The basic constituent elements including the multilayer member 12′ and the external packaging member 50 in the battery 10A of Example 2 may be the same as those in the battery 10 of Example 1. In Example 1 and Example 2, the size of the negative electrode member 30 may be larger than that of the positive electrode member 20. Namely, the periphery of the negative electrode member 30 may be located outside of the periphery of the positive electrode member 20. In this case, the deposition of lithium in the negative electrode member 30 can be prevented. The size of the separator 40 may be larger than the size of the positive electrode member 20 and the size of the negative electrode member 30. Namely, the periphery of the separator 40 may be located outside of the periphery of the positive electrode member 20 and the periphery of the negative electrode member 30.

In the battery of Example 2, the electrolyte has a gel-like form. Therefore, when the battery is curled, the positive electrode member and the negative electrode member are less likely to move relative to each other. The external packaging member is provided with at least a resin layer having a Young's modulus of 3 GaPa or more. In this case, the excessive deformation of the external packaging member can be prevented, as mentioned above. As a result, a battery having high safety and flexibility and having high resistance to bending can be provided.

Example 3 relates to a battery according to the third aspect of the present disclosure. The schematic cross-sectional views of the multilayer member constituting the battery of Example 3 and the battery are the same as FIG. 11A and FIG. 11B, and the schematic plan view of the battery of Example 3 is the same as FIG. 11C.

A battery 10A according to the third aspect of the present disclosure is provided with an electrode body 12′ having a laminated structure and an external packaging member 50 which houses the electrode body 12′ therein,

wherein:

the external packaging member 50 is provided with an aluminum-containing metal layer 52, a first resin layer 51 arranged on a first surface of the metal layer 52, and a second resin layer 53 arranged on a second surface of the metal layer 52;

the external packaging member 50 houses the electrode body 12′ therein in such a manner that the first resin layer 51 can be located on an outer side; and

the first resin layer 51 contains at least one of polyethylene terephthalate and polyethylene naphthalate and has a thickness of more than 40 μm.

In the battery of Example 3, a first adhesive agent layer is provided between the resin layer (first resin layer) 51 and the intermediate layer (metal layer) 52, and a second adhesive agent layer is provided between the intermediate layer 52 and the heat-sealable material layer (second resin layer) 53. Each of the first adhesive agent layer and the second adhesive agent layer is made from, for example, an acrylic adhesive agent. In each of the first adhesive agent layer and the second adhesive agent layer, empty spaces (empty spaces, openings or through-holes penetrating through the first adhesive agent layer as observed in the thickness direction) may be provided. The empty spaces may be provided in a regular pattern or randomly. Examples of the planar form of the empty spaces include, but are not limited to: a net-like form, a grid-like form, a stripe-like form, an island-like form, a concentric form, a spiral form, a radial form, a dot-like form, a geometric pattern-like form and an amorphous form. The first adhesive agent layer and the second adhesive agent layer can be applied to the batteries mentioned in Example 1 to Example 2.

Concretely, the battery 10 of Example 3A was produced in the following manner. Namely, in the battery 10 of Example 3A, the positive electrode member 20 was produced in the same manner as in Example 1, except that the positive electrode conductive agent was made from Ketjen black, and the positive electrode binder was made from polyvinylidene fluoride. An aluminum-made positive electrode lead part was attached to the positive electrode current collector 21 by welding.

On the other hand, a negative electrode mix was prepared by mixing 95.5 parts by mass of graphite that served as a negative electrode active material, 1.0 part by mass of carbon black that served as a negative electrode conductive agent, and 3.5 parts by mass of polyvinylidene fluoride that served as a negative electrode binder together, then the negative electrode mix was dispersed in N-methyl-2-pyrrolidone to prepare a paste-like negative electrode mix slurry, and a negative electrode member 30 was produced in the same manner as in Example 1. A nickel-made negative electrode lead part was attached to the negative electrode current collector 31 by welding.

A gel-like electrolyte layer was formed on the surface of each of the positive electrode mix layer and the negative electrode mix layer in the following manner. Firstly, 18.62 parts by mass of ethylene carbonate (EC) and 18.62 parts by mass of propylene carbonate (PC) were mixed together to prepare a mixed solvent, and then 5.95 parts by mass of lithium hexafluorophosphate (LiPF₆) was dissolved in the mixed solvent to prepare an electrolyte solution. Subsequently, 3.37 parts by mass of polyvinylidene fluoride (PVDF) that served as a polymeric compound, 5.90 parts by mass of alumina particles that served as inorganic particles, and 47.54 parts by mass of dimethyl carbonate (DMC) that served as a dilution solvent were added to the electrolyte solution, then the resultant solution was stirred and dissolved together to prepare a precursor solution that was a sol-like electrolyte solution. Subsequently, the prepared precursor solution was applied onto the surface of each of the positive electrode mix layer and the negative electrode mix layer, and then the precursor solution was dried to remove the dilution solvent, thereby producing a gel-like electrolyte layer. The use of alumina particles as the inorganic particles can be applied to the batteries mentioned in Example 1 to Example 2.

A microporous film made from a polypropylene resin was cut into a rectangular shape, which was used as a separator 40. A negative electrode member 30, the separator 40 and a positive electrode member 20 were laminated in such a manner that the negative electrode mix layer and the positive electrode mix layer face each other with the separator 40 interposed therebetween to produce a multilayer member 12′. In the lamination, the relative position between the positive electrode member 20 and the negative electrode member 30 was adjusted such that an orthographically projected image of the positive electrode member 20 could be enclosed within an orthographically projected image of the negative electrode member 30 as observed from the lamination direction.

As film-like external packaging members, moisture-resistant aluminum laminate films (total thickness: 86 μm, 96 μm, 106 μm and 116 μm) were prepared, in each of which a resin layer, an intermediate layer and a heat-sealable material layer were overlaid in this order as observed from the outside. The specific constitutions of the layers are shown in Table 3 below.

Subsequently, the external packaging member 50 was folded back in such a manner that the multilayer member 12′ was sandwiched by the heat-sealable material layer (also see FIG. 23), the folded peripheries were overlaid on each other. In this case, an acid-modified propylene film (adhesive film 24, 34) was inserted between an overhanging part 23A, 23B and the external packaging member 50. Subsequently, the overlaid peripheries were thermally fusion-bonded to hermetically seal the multilayer member 12′ with the external packaging member 50. In this case, the folded part in the external packaging member 50 was also thermally fusion-bonded.

The whole body of the battery was heat-pressed to integrate the positive electrode member 20 that constituted a multilayer member 12′, the separator 40 and the negative electrode member 30 to one another. In this manner, a battery 10A of Example 3A which had a rectangular shape and having a size of 25 mm wide, 75 mm long and 0.45 mm deep was produced. In the same manner, the batteries of Example 3B, Reference Example 3D and Reference Example 3E were produced.

A battery 10 of Example 3C was produced in the following manner. Namely, the same procedure as in Example 3A was carried out to produce a multilayer member 12, except that a positive electrode member 20 and a negative electrode member 30 each having no gel-like electrolyte layer formed therein were used in the battery 10 of Example 3C. Subsequently, an external packaging member 50 was folded back so as to sandwich a multilayer member 12 therein in the same manner as in Example 3A, and the folded peripheries were overlaid on each other. As the external packaging member 50, the same member as that used in Example 3A was used. Subsequently, two among three sides at which the external packaging member 50 was overlaid were thermally fusion-bonded, the remaining one side was left without thermally fusion-bonding the one side and employed as an opening, and the folded part in the external packaging member 50 was also thermally fusion-bonded. Subsequently, an electrolyte solution which was prepared in the same manner as in Example 3A was injected through the opening of the external packaging member 50, and then the remaining one side of the external packaging member 50 was thermally fusion-bonded under a reduced pressure to hermetically seal the one side. In this manner, a battery of Example 3C which had a rectangular shape and had an electrolyte layer (made from a non-aqueous electrolyte solution) in place of a gel-like electrolyte layer was produced. In the same manner, a battery of Reference Example 3F was produced.

Batteries of Comparative Example 3A, Comparative Example 3B, Comparative Example 3C, Comparative Example 3D, Comparative Example 3E and Comparative Example 3F were produced in the same manner as in Example 3A, Example 3B, Example 3C, Reference Example 3D, Reference Example 3E, Reference Example 3F, except that an external packaging member provided with a polypropylene (PP) film in place of a PET film as a resin layer was used, as shown in Table 4.

TABLE 3
Resin layer
Example 3A: a PET film 50 μm (a gel-like electrolyte layer)
Example 3B: a PET film 60 μm (a gel-like electrolyte layer)
Example 3C: a PET film 50 μm (an electrolyte layer)
Reference Example 3D: a PET film 30 μm (a gel-like electrolyte layer)
Reference Example 3E: a PET film 40 μm (a gel-like electrolyte layer)
Reference Example 3F: a PET film 30 μm (an electrolyte layer)
First adhesive agent layer: an acrylic adhesive agent layer
Intermediate layer: an aluminum foil (thickness: 20 μm)
Second adhesive agent layer: an acrylic adhesive agent layer
Heat-sealable material layer: a non-stretched polypropylene (CPP) film
(thickness: 30 μm)

TABLE 4
Resin layer
Comparative Example 3A: a PP film 50 μm (a gel-like electrolyte layer)
Comparative Example 3B: a PP film 60 μm (a gel-like electrolyte layer)
Comparative Example 3C: a PP film 50 μm (an electrolyte layer)
Comparative Example 3D: a PP film 30 μm (a gel-like electrolyte layer)
Comparative Example 3E: a PP film 40 μm (a gel-like electrolyte layer)
Comparative Example 3F: a PP film 30 μm (an electrolyte layer)
First adhesive agent layer: an acrylic adhesive agent layer
Intermediate layer: an aluminum foil (thickness: 20 μm)
Second adhesive agent layer: an acrylic adhesive agent layer
Heat-sealable material layer: a non-stretched polypropylene (CPP)
film (thickness: 30 μm)

The capacity retention of each of the batteries of Example 3, Reference Example 3 and Comparative Example 3 which were produced in the above-mentioned manner was evaluated in the following manner. Firstly, the battery was subjected to one cycle of charging-discharging procedure under an ambient temperature environment (23° C.) to measure the discharge capacity after the 1^{st} cycle. The charging and discharging conditions are shown below.

### Charge: CC (Constant Current)/CV (Constant Voltage)

4.2 volts, 1 ItA, 2.5 hours

### Discharge: CC (Constant Current)

1 ItA, 3.0 volts cut-off

Subsequently, the battery was charged until the SOC became 50%, and the battery (also mentioned as “thin film battery” in FIG. 12A and FIG. 12B) was sandwiched by two long sheets (wherein the resultant product was referred to as a “test sample”, hereinafter, and was mentioned as “laminate” in FIG. 12A and FIG. 12B). In this case, the position of the battery relative to the sheets was adjusted so that the length direction of the battery and the length direction of the sheets could match each other. Subsequently, both ends of the test sample was held by gripping sections of a bending test machine in such a manner that the test sample could become horizontal. Subsequently, the test sample was sandwiched by a pair of cylindrical bodies from both of the main surface sides. Subsequently, as shown in FIG. 12B, the pair of cylindrical bodies were moved upward while sandwiching the test sample by the pair of cylindrical bodies to curl the test sample convexly. In this case, the angle of the curling was 120 degrees. Subsequently, the pair of cylindrical bodies were got down until the test sample became horizontal. A bending test, in which the pair of cylindrical bodies were moved upward and downward to repeatedly curl the test sample convexly, was repeated 10,000 times.

Subsequently, the battery was subjected to a charge-discharge procedure repeatedly in an ambient environment (23° C.) until the number of cycles became 200 cycles in total, and then the discharge capacity after each cycle was measured. The charge-discharge conditions were the same as those employed for the 1st cycle of the charge-discharge procedure. Subsequently, a procedure in which the bending test was carried out 10,000 times and then a charge-discharge procedure was repeated 200 cycles was repeated. Subsequently, from the results of the discharge capacity, the capacity retention rate [%] after n cycle(s) {=(a discharge capacity after the n^{th} cycle)/(a discharge capacity after the 1^{st} cycle)]×100) was determined.

For comparison, a discharge capacity retention was determined in the same manner as in the above-mentioned discharge capacity retention measurement, except that the battery of Example 3A was not subjected to a bending test.

In FIG. 13, the results of the evaluation of discharge capacity retention of the batteries of Example 3A, Example 3B, Reference Example 3D, Reference Example 3E, Comparative Example 3A, Comparative Example 3B, Comparative Example 3D and Comparative Example 3E are shown. From FIG. 13, it is demonstrated that the discharge capacity retention of the battery of Example 3 which had a resin layer containing a PET resin was higher than that of the batter of Comparative Example 3 which had a resin layer containing a PP resin. It is considered that this difference in discharge capacity retention occurs for the following reasons. Namely, in each of the batteries of Comparative Example 3A, Comparative Example 3B, Comparative Example 3D and Comparative Example 3E, the hardness of the resin layer containing a PP resin is poor, and therefore the shape retention performance of the intermediate layer against external force is deteriorated, and the intermediate member in the external packaging member is cracked when the battery is curled repeatedly. As a result, the hermeticity of the battery is deteriorated and water is invaded, and the discharge capacity retention against the charge-discharge cycle is also deteriorated. On the other hand, in each of the batteries of Example 3A, Example 3B, Reference Example 3D and Reference Example 3E, the hardness of the resin layer containing a PET resin is higher than that of the resin layer containing a PP resin, and therefore the shape retention performance of the intermediate layer against an external force can be improved and the cracking of the intermediate layer in the external packaging member is less likely to occur even when the battery is curled repeatedly. As a result, the hermeticity of the battery can be maintained, the invasion of water can be prevented, and therefore the deterioration in discharge capacity retention against the charge-discharge cycle can be prevented.

From FIG. 13, it is demonstrated that the deterioration in discharge capacity retention can be prevented more effectively with the increase in the thickness of the resin layer. This is because the cracking is less likely to occur in the intermediate layer in the external packaging member with the increase in the thickness of the resin layer even when the battery is curled repeatedly. From the comparison between the battery of Example 3 which had a resin layer containing a PET resin with the battery of Reference Example 3, it is demonstrated that the deterioration in discharge capacity retention against the charge-discharge cycle can be particularly prevented when the thickness of the resin layer is increased to more than 40 μm.

In FIG. 14, the results of the evaluation of discharge capacity retention of the batteries of Example 3A, Example 3C, Reference Example 3D, Reference Example 3F, Comparative Example 3A, Comparative Example 3C, Comparative Example 3D and Comparative Example 3F are shown. It is demonstrated that the discharge capacity retention of a battery using a gel-like electrolyte as the electrolyte (Example 3A) is higher than that of a battery using an electrolyte solution as the electrolyte (Example 3C). It is considered that the reason for this difference in discharge capacity retention is as follows. Namely, in a battery using an electrolyte solution as the electrolyte, the positive electrode member and the negative electrode member can move easily relative to each other with the separator interposed therebetween, and therefore the positive electrode member or the negative electrode member may be damaged when the battery is curled repeatedly. In the damaged part in the positive electrode member or the negative electrode member, the deposition of lithium may occur easily, and therefore the discharge capacity retention against the charge-discharge cycle is deteriorated. On the other hand, in a battery in which a gel-like electrolyte is used as the electrolyte, the positive electrode member and the negative electrode member are less likely to move easily relative to each other with the separator interposed therebetween, and therefore the positive electrode member or the negative electrode member is less likely to be damaged even when the battery is curled repeatedly. As a result, the deposition of lithium can be prevented and therefore the deterioration in discharge capacity retention against the charge-discharge cycle can be prevented.

As mentioned above, it is found that, in order to improve the bending resistance of a battery against repeated curling, it is required to increase the thickness of the resin layer to more than 40 μm using a resin layer containing a PET resin. In order to further improve the bending resistance, the thickness of the resin layer is preferably adjusted to 45 μm or more, more preferably 50 μm or more. Furthermore, from the viewpoint of the improvement in bending resistance, it is preferred to use a gel-like electrolyte as the electrolyte.

In Example 4, a battery according to the present disclosure or the like (more specifically, a lithium ion secondary battery) and application examples of the battery will be described.

The batteries (more specifically lithium ion secondary batteries) according to the present disclosure or the like which are described in Example 1 to Example 3 can be applied to, without limitation, a machine, a device, a tool, an apparatus and a system (i.e., an assembly of a plurality of devices) in each of which a battery can be used as a power supply for driving/operating purposes or an electric power storage source for electric power reservation purposes. When used as a power supply, the battery may be a main power source (i.e., a power supply which is used preferentially) or an auxiliary power supply (i.e., a power supply to be used in place of a main power supply or a power supply that can be switched from a main power supply). In the case where the battery of the present disclosure is used as an auxiliary power supply, the type of a main power supply is not limited to the battery of the present disclosure.

Examples of the use application of the battery (more specifically lithium ion secondary battery) of the present disclosure include, but not limited to: an electronic device or electric device (including a mobile electronic device), such as a video camera, a cam corder, a digital still camera, a mobile phone, a personal computer, a television receiver, a display device, a codeless phone, a headset stereo, a music player, a portable radio, an electric paper (e.g., an electric book and an electric newspaper), and a mobile information terminal including a PDA; a toy; a mobile daily instrument such as an electronic shaver; a lighting tool, such as a room light; a medical electric device such as a pacemaker and a hearing aid; a storage device such as a memory card; a battery pack to be used as a removable power supply in a personal computer or the like; a wearable device (e.g., a smartwatch, a wrist band, a smart eyeglass, a health care product); an electric power tool such as an electric drill and an electric saw; an electric power storage system for accumulating an electric power for emergencies and the like, such as a battery system for home use, a home energy server (e.g., an electrical storage device for home use), and an electric power supply system; an electrical storage unit and a backup power supply; an electric vehicle such as an electric car, an electric motorcycle, an electric bicycle and Segway (registered trademark); and the driving of a power driving force transducer (more specifically, a power motor or the like) for aircrafts and ships.

Particularly, the battery according to the present disclosure can be used effectively in a battery pack, an electric vehicle, an electric power storage system, an electric power supply system, an electric power tool, an electronic device, an electric device and the like. A battery pack is a power supply equipped with the battery of the present disclosure, and may be a so-called assembled battery or the like. An electric vehicle is a vehicle that can be operated (run) using the battery of the present disclosure as a driving power supply, and may be an automobile that is also equipped with a driving power source other than a battery (e.g., a hybrid car). An electric power storage system or an electric power supply system is a system in which the battery of the present disclosure is used as an electric power storage source. For example, in an electric power storage system (or electric power supply system) for home use, an electric power is accumulated in the battery of the present disclosure that serves as an electric power storage source. Therefore, an electric appliance for home use or the like can be used by utilizing the electric power. An electric power tool is a tool in which a movable unit (e.g., a drill) is driven utilizing the battery of the present disclosure as a driving power supply. An electronic device or an electric device is a device that can exert various functions thereof by utilizing the battery of the present disclosure as a driving power supply (an electric power supply source).

The battery pack is a construct-simplified battery pack (i.e., a so-called soft pack) equipped with the battery of the present disclosure, and can be installed in an electronic device typified by a smart phone. Alternatively, the battery pack may be equipped with an assembled battery composed of six batteries of the present disclosure which are connected to one another in a (2 in parallel)×(3 in series) configuration. The batteries may be connected in series, or in parallel or in a mixed state thereof.

A block diagram illustrating a circuit configuration example in which the battery according to the present disclosure or the like is used in a battery pack is shown in FIG. 15. The battery pack is provided with a cell (assembled battery) 1001, an external packaging member, a switching unit 1021, a current detection resistor 1014, a temperature detection element 1016 and a control unit 1010. The switching unit 1021 is provided with a charge control switch 1022 and a discharge control switch 1024. The battery pack is also provided with a positive electrode terminal 1031 and a negative electrode terminal 1032. During charging, the positive electrode terminal 1031 and the negative electrode terminal 1032 are respectively connected to a positive electrode terminal and a negative electrode terminal in a charger to perform charging. During the use of an electronic device, the positive electrode terminal 1031 and the negative electrode terminal 1032 are respectively connected to a positive electrode terminal and a negative electrode terminal in the electronic device to perform discharging.

The cell 1001 is composed of a plurality of the batteries 1002 of the present disclosure or the like which are connected in series and/or in parallel. In FIG. 15, six lithium ion batteries 1002 are connected to one another in a (2 in parallel)×(3 in series) (2P3S) configuration. Alternatively, the batteries may be connected in any way, including a (p in parallel)×(q in series) configuration (wherein each of p and q represents an integer).

The switching unit 1021 is proved with a charge control switch 1022 and a diode 1023 and a discharge control switch 1024 and a diode 1025, and can be controlled by a control unit 1010. The diode 1023 has polarity that directs in the backward direction relative to a charge current that flows from the positive electrode terminal 1031 toward the cell 1001 and also directs in the forward direction relative to a discharge current that flows from the negative electrode terminal 1032 toward the cell 1001. The diode 1025 has polarity that directs in the forward direction relative to the discharge current and is also directs in the backward direction relative to the discharge current. In the example shown in FIG. 15, the switching unit is arranged on the positive (+) side. However, the switching unit may also be arranged on the negative (−) side. The charge control switch 1022 can be controlled by the control unit 1010 in such a manner that the charge control switch 1022 is made in a closed state when the battery voltage reaches an overcharge detection voltage so that a charge current cannot flow through a current passage of the cell 1001. After the charge control switch 1022 comes into a closed state, only the discharge becomes possible through the diode 1023. The charge control switch 1022 can also be controlled by the control unit 1010 in such a manner that the charge control switch 1022 is made in a closed state when a high current flows during charging so that a charge current flowing through the current passage of the cell 1001 can be blocked. The discharge control switch 1024 can be controlled by the control unit 1010 in such a manner that the discharge control switch 1024 is made in a closed state when the battery voltage reaches an overdischarge detection voltage so that a discharge current flowing through the current passage of the cell 1001 can be blocked. After the discharge control switch 1024 comes into a closed state, only the charge becomes possible through the diode 1025. The discharge control switch 1024 can also be controlled by the control unit 1010 in such a manner that the discharge control switch 1024 is made in a closed state when a high current flows during discharging so that a discharge current flowing through the current passage of the cell 1001 can be blocked.

The temperature detection element 1016 is composed of, for example, a thermistor and is arranged in the vicinity of the cell 1001, and the temperature measurement unit 1015 measures the temperature of the cell 1001 by means of the temperature detection element 1016 and sends the measurement results to the control unit 1010. The voltage measurement unit 1012 measures the voltage of the cell 1001 and the voltage of each of the lithium ion secondary batteries 1002 that constitute the cell 1001, then A/D-converts the measurement results and sends the converted results to the control unit 1010. The current measurement unit 1013 measures a current using a current detection resistor 1014 and sends the measurement results to the control unit 1010.

The switch control unit 1020 controls the charge control switch 1022 and the discharge control switch 1024 in the switching unit 1021 on the bases of the voltage or current sent from the voltage measurement unit 1012 and the current measurement unit 1013. The switch control unit 1020 sends a control signal to the switching unit 1021 when the voltage of any one of the lithium ion secondary batteries 1002 reaches an overcharge detection voltage or less or an overdischarge detection voltage or less or when a high current flows rapidly, thereby preventing the occurrence of overcharging, overdischarging or overcurrent charging-discharging. Each of the charge control switch 1022 and the discharge control switch 1024 may be composed of a semiconductor switch such as a MOSFET. In this case, each of the diodes 1023 and 1025 is composed of a parasitic diode for a MOSFET. In the case where a p-channel-type FET is used as the MOSFET, the switch control unit 1020 supplies a control signal DO and a control signal CO to a gate unit of the charge control switch 1022 and a gate unit of the discharge control switch 1024, respectively. The charge control switch 1022 and the discharge control switch 1024 can be electrically conducted by a gate potential that is lower by a predetermined value than the source potential. Namely, in the common charge-discharge operation, each of the control signal CO and the control signal DO is adjusted to a low level to make both of the charge control switch 1022 and the discharge control switch 1024 in an electrically conducted state. In overcharging or overdischarging, for example, each of the control signal CO and the control signal DO is adjusted to a high level to make both of the charge control switch 1022 and the discharge control switch 1024 in a closed state.

The memory 1011 includes, for example, an EPROM (Erasable Programmable Read Only Memory) that is a non-volatile memory. In the memory 1011, a numerical value calculated by the control unit 1010, a value of a lithium ion secondary battery internal resistance in each of the lithium ion secondary batteries 1002 in an initial state which is measured in the production step, and the like are stored in advance, and these values is rewritable as required. By storing a full charge capacity of each of the lithium ion secondary batteries 1002, the memory 1011 can calculate a remaining capacity or the like in conjunction with the control unit 1010.

In the temperature detection element 1015, a temperature is measured using the temperature detection element 1016, the charging and discharging are controlled upon the occurrence of any abnormal event, and makes correction in the calculation of a remaining capacity.

Next, a block diagram illustrating the configuration of an electric vehicle, such as a hybrid car that is one example of the electric vehicle is shown in FIG. 16A. The electric vehicle is equipped with, for example: a metal-made housing 2000; and a control unit 2001, various sensors 2002, a power supply 2003, an engine 2010, an electricity generator 2011, inverters 2012 and 2013, a driving motor 2014, a differential device 2015, a transmission 2016 and a clutch 2017. In addition, the electric vehicle is also equipped with, for example, a front wheel drive shaft 2021, front wheels 2022, a rear wheel drive shaft 2023 and rear wheels 2024 all of which are connected to the differential device 2015 and the transmission 2016.

The electric vehicle can run by utilizing either one of the engine 2010 and the motor 2014 as a driving power source. The engine 2010 is a main power source, such as a gasoline engine. In the case where the engine 2010 is used as a power source, a driving force (rotational force) of the engine 2010 is transmitted to the front wheels 2022 and the rear wheels 2024 through the differential device 2015, the transmission 2016 and the clutch 2017 which are driving units, for example. The rotational force of the engine 2010 is also transmitted to the electricity generator 2011, and therefore the electricity generator 2011 generates an alternate current electric power utilizing the rotational force. The alternate current electric power is converted to a direct current electric power through the inverter 2013, and the direct current electric power is accumulated in the power supply 2003. On the other hand, in the case where the motor 2014, which is a conversion unit, is used as a power source, an electric power (direct current electric power) supplied from the power supply 2003 is converted to an alternate current electric power through the inverter 2012, and the motor 2014 is driven utilizing the alternate current electric power. A driving force (rotational force) converted from the electric power by the motor 2014 is transmitted to the front wheels 2022 or the rear wheels 2024 through the differential device 2015, the transmission 2016 and the clutch 2017 which are driving units, for example.

When the electric vehicle is deaccelerated through a damping mechanism (not shown), a resisting force generated during the deacceleration is transmitted to the motor 2014 as a rotational force. It is also possible to generate an alternate current electric power by the motor 2014 by utilizing the rotational force. The alternate current electric power is converted to a direct current electric power through the inverter 2012, and the direct-current regenerative electric power is accumulated in the power supply 2003.

The control unit 2001 controls the entire operation of the electric vehicle, and is equipped with, for example, a CPU. The power supply 2003 is equipped with at least one lithium ion secondary battery (not shown) which is described in Example 1 to Example 3. It is also possible that the power supply 2003 is connected to an external power supply and receives the supply of an electric power from the external power supply so as to accumulate the electric power therein. The various sensors 2002 are used, for example, for controlling the rotating speed of the engine 2010 and also controlling the opening angle of a throttle valve (not shown) (throttle opening angle). The various sensors 2002 include, for example, a speed sensor, an acceleration sensor and an engine rotating speed sensor.

In this section, a case where the electric vehicle is a hybrid car is described. However, the electric vehicle may be a vehicle that can be driven using only the power supply 2003 and the motor 2014 without the need to utilize the engine 2010 (i.e., an electric car).

Next, a block diagram illustrating the configuration of an electric power storage system (electric power supply system) is shown in FIG. 16B. The electric power storage system is equipped with, for example: a house 3000 such as a conventional home and a commercial building; and a control unit 3001, a power supply 3002, a smart meter 3003 and a power hub 3004 all of which are housed in the house 3000.

The power supply 3002 can be connected to an electric device (an electronic device) 3010 that is placed in the house 3000, and can also be connected to an electric vehicle 3011 that is parked at the outside of the house 3000. Alternatively, the power supply 3002 can be connected to a private electricity generator 3021 that is placed in the house 3000 through the power hub 3004, and can also be connected to an external centralized electric power system 3022 through the smart meter 3003 and the power hub 3004. The electric device (electronic device) 3010 also includes, for example, at least one home appliance. Examples of the home appliance include a refrigerator, an air conditioner, a television receiver and a water heater. The private electricity generator 3021 includes, for example, a solar electricity generator, a wind electricity generator and the like. Examples of the electric vehicle 3011 include an electric car, a hybrid car, an electric motorcycle, an electric bicycle, and a Segway (registered trademark). Examples of the centralized electric power system 3022 include an electric power supply for commercial use, an electricity generator, a power grid and a smart grid (a next-generation power grid), and also include a thermal power plant, a nuclear power plant, a hydroelectric power plant and a wind power plant. In addition, examples of an electricity generator to be provided in the centralized electric power system 3022 include, but are not limited to, various solar batteries, fuel cells, wind power plants, micro-hydroelectric power plants and geothermal power plants.

The control unit 3001 controls the entire operation of the electric power storage system (including the state of usage of the power supply 3002), and is provided with, for example, a CPU. The power supply 3002 includes at least one lithium ion secondary battery (not shown) that is mentioned in Example 1 to Example 3. The smart meter 3003 is, for example, a network-compatible electric power meter to be installed in a house 3000 that demands an electric power, and can communicate with an electric power supplier side. The smart meter 3003 controls the demand-supply balance in the house 3000 while communicating with an outside to thereby enable the highly efficient and steady energy supply.

In the electric power storage system, an electric power from the centralized electric power system 3022, which is an external power supply, is accumulated in the power supply 3002 through the smart meter 3003 and the power hub 3004, and an electric power from the private electricity generator 3021, which is an independent power supply, is accumulated in the power supply 3002 through the power hub 3004. The electric power accumulated in the power supply 3002 is supplied to the electric device (electronic device) 3010 and the electric vehicle 3011 in response to a command from the control unit 3001. As a result, the electric device (electronic device) 3010 becomes in an operable state and the electric vehicle 3011 becomes in a chargeable state. Namely, the electric power storage system is a system that enables the accumulation and supply of an electric power in the house 3000 by utilizing the power supply 3002.

The electric power accumulated in the power supply 3002 can be used as required. Therefore, it is possible, for example, that an electric power from the centralized electric power system 3022 is accumulated in the power supply 3002 during midnight in which an electric power rate is inexpensive and the electric power accumulated in the power supply 3002 is used during the day in which an electric power rate is expensive.

The above-mentioned electric power storage system may be installed in every house (every family), or may be installed in every several houses (every several families).

Next, a block diagram illustrating the configuration of an electric power tool is shown in FIG. 16C. The electric power tool is, for example, an electric drill, and is equipped with, for example: a tool main body 4000 made from a plastic material or the like; and a control unit 4001 and a power supply 4002 both of which are arranged in the tool main body 4000. In the tool main body 4000, a drill part 4003, which is a movable unit, is installed rotatably. The control unit 4001 controls the entire operation of the electric power tool (including the state of usage of the power supply 4002), and is provided with, for example, a CPU. The power supply 4002 includes at least one lithium ion secondary battery (not shown) mentioned in Example 1 to Example 3. The control unit 4001 supplies an electric power from the power supply 4002 to the drill part 4003 in response to the operation of an operation switch.

Next, an application example in which the battery mentioned in the section “EXAMPLES” is applied to a flexible printed circuit board (also simply referred to as a “printed circuit board”, hereinafter) will be described. As shown in FIG. 17, a battery 5003 is mounted on a printed circuit board 5002 together with a charge circuit and others. An object in which a battery 5003 and an electronic circuit such as a charge circuit are mounted on a printed circuit board 5002 is referred to as a “battery module 5001”. The battery module 5001 may be configured in the form of a card as required, and can be configured in the form of a portable card-type mobile battery.

On the printed circuit board 5002 are mounted a battery 5003, a charge control IC 5004, a battery protection IC 5005 and a remaining battery level monitoring IC 5006. The battery protection IC 5005 controls the charge-discharge operation in such a manner that the charge voltage does not become too large during charging and discharging, an overcurrent does not flow as the result of the occurrence of load short circuit and overdischarge never occurs.

A USB interface 5007 is attached to the printed circuit board 5002. The battery 5003 is charged with an electricity supplied through the USB interface 5007. In this case, the charging operation is controlled by the charge control IC 5004. Furthermore, a predetermined electricity (e.g., a voltage of 4.2 V) is supplied to a load 5009 from load connection terminals 5008a and 5008b attached to a substrate 5002. The remaining battery level of the battery 5003 is monitored by a remaining battery level monitoring IC 5006, and the remaining battery level (not shown) is displayed so as to be viewed from the outside. For the connection of the load, a USB interface 5007 may be used.

Specific examples of the above-mentioned load 5009 are as follows.

1. A wearable device (e.g., a sport-type watch, a watch, a hearing aid)

2. An IoT terminal (e.g., a sensor network terminal)

3. An amusement device (e.g., a portable game terminal, a game controller)

4. An IC substrate-embedded battery (e.g., a realtime clock IC)

5. An environmental electricity generator (e.g., an electrical storage element for electricity generation element for solar power generation, thermoelectric power generation, vibration power generation or the like)

Next, an application example in which the battery described in the section “EXAMPLES” is applied to a universal credit card will be described. A universal credit card is one example of an IC card. Currently, many people carry a plurality of credit cards. However, the problem that risk such as loss and theft of credit cards increases with the increase in the number of the credit cards. Then, a single credit card that covers a multiple credit cards by itself has been put into practical use. The credit card of this type is called a “universal credit card”.

In FIG. 18, one example of the configuration of a universal credit card 6001 is shown. The universal credit card 6001 has an almost identical size to those of conventional credit cards, and has an IC chip and a battery both embedded therein. The universal credit card 6001 is also provided with a reduced-power-consumption-type display 6002 and a manipulation unit (e.g., arrow keys 6003a and 6003b). In addition, a charging terminal 6004 is provided on the surface of the universal credit card 6001. A user of the universal credit card 6001 can manipulate the arrow keys 6003a and 6003b while watching the display 6002 to identify a credit card that is loaded in the universal credit card 6001 in advance. In the case where a plurality of credit cards are loaded in advance, information showing the credit cards is displayed on the display 6002, and the user can specify a desired credit card by manipulating the arrow keys 6003a and 6003b. After that, the universal credit card 6001 can be used in the same manner as the conventional credit cards.

Next, an application example in which the battery mentioned in the section “EXAMPLES” is applied to a wristband-type electronic device will be described. As one of wearable terminals, a wristband-type activity tracker can be mentioned. A wristband-type activity tracker is also called a “smart band”, and various data associated with the activity of a human body, such as the number of steps, travel distance, consumed calorie, the amount of sleep and heart rate, can be obtained merely by winding the wristband-type activity tracker around an arm. Furthermore, the obtained data can be managed using a smartphone. The wristband-type activity tracker may also have a notification function for notifying the entry of a mail to a user by means of an LED lamp and vibration.

In FIG. 19 and FIG. 20, an example of the configuration of a wristband-type activity tracker for measuring a pulse beat is shown. In FIG. 19, one example of the appearance of a wristband-type activity tracker 7001 is shown. In FIG. 20, one example of the configuration of a main body part 7002 of the wristband-type activity tracker 7001 is shown.

The wristband-type activity tracker 7001 is a wristband-type measurement device for measuring, for example, the pulse beat of a subject in an optical mode. As shown in FIG. 19, the wristband-type activity tracker 7001 is composed of a main body part 7002 and a band 7003 and can be worn on the arm (wrist) 7004 of a subject like a wrist watch. The main body part 7002 emits measurement light having a predetermined wavelength toward a part including pulse on the arm 7004 of the subject, and the pulse beat of the subject is measured on the basis of the intensity of reflected light.

The main body part 7002 includes a substrate 7021, a LED 7022, a light-receiving IC 7023, a light blocker 7024, a manipulation unit 7025, a calculation processing unit 7026, a display unit 7027 and a wireless device 7028. The LED 7022, the light-receiving IC 7023 and the light blocker 7024 are provided on the substrate 7021. The LED 7022 emits measurement light having a predetermined wavelength toward a pulse-measuring part of the arm 7004 of the subject under the control by the light-receiving IC 7023. The measurement light is emitted onto the arm 7004 and is reflected by the arm 7004, and reflected light is received by the light-receiving IC 7023. The light-receiving IC 7023 produces a digital measurement signal that indicates the intensity of the reflected light, and supplies the produced measurement signal to the calculation processing unit 7026.

The light blocker 7024 is provided between the LED 7022 and the light-receiving IC 7023 on the substrate 7021. The light blocker 7024 prevents the direct entry of the measurement light to the light-receiving IC 7023 from the LED 7022.

The manipulation unit 7025 is composed of various manipulation units such as a button and a switch, and is provided on the surface of the main body part 7002 or the like. The manipulation unit 7025 is used for the manipulation of the wristband-type activity tracker 7001, and supplies a signal indicating the content of manipulation to the calculation processing unit 7026. The calculation processing unit 7026 performs a calculation processing for determining the pulse beat of the subject on the basis of the measurement signal supplied from the light-receiving IC 7023. The calculation processing unit 7026 supplies the results of the measurement of pulse beat to the display unit 7027 and the wireless device 7028. The display unit 7027 is composed of, for example, a display device such as a liquid crystal display device, and is provided on the surface of the main body part 7002. The display unit 7027 displays thereon, for example, the results of the measurement of pulse beat of the subject.

The wireless device 7028 sends the results of the measurement of pulse beat of a subject to an external device through wireless radio communication of a predetermined mode. For example, as shown in FIG. 20, the wireless device 7028 sends the results of the measurement of pulse beat of the subject to a smartphone 7005 and allows to display the measurement results on a screen 7006 of the smartphone 7005. Furthermore, it also becomes possible to manage the data of the measurement results by the smartphone 7005 so that the measurement results can be browsed in the smartphone 7005 or can be stored in a server on the network. As the communication mode of the wireless device 7028, any mode can be employed. The light-receiving IC 7023 can also be used for the measurement of pulse beat on a part other than the arm 7004 in the subject (e.g., a finger, an ear lobe).

The wristband-type activity tracker can measure the pulse wave or the pulse beat of a subject accurately without the influence of body motions by means of a signal processing in the light-receiving IC 7023. For example, even when a subject does an intense physical exercise such as running, the pulse wave or the pulse beat of the subject can be measured accurately. In addition, for example, in the case where a subject wears the wristband-type activity tracker 7001 for a long time for measurement, the measurement of the pulse wave or the pulse beat can be continued accurately while without the influence of the body motions of the subject.

The consumed power of the wristband-type activity tracker 7001 can be reduced by reducing the amount of calculation. As a result, it becomes possible to perform the measurement while the subject wearing the wristband-type activity tracker 7001 for a long time without needing to perform charging or battery change.

As a power supply, the battery mentioned in Example 1 to Example 3 is installed in the band 7003. The wristband-type activity tracker 7001 is provided with an electronic circuit of the main body and a battery pack. For example, the wristband-type activity tracker 7001 is so configured that the battery pack can be removed freely by a user. The electronic circuit is a circuit included in the main body part 7002.

In FIG. 21 and FIG. 22, one example of the configuration of the wristband-type electronic device is shown. FIG. 21 shows one example of the appearance of the wristband-type electronic device 8001. FIG. 22 shows one example of the configuration of the wristband-type activity tracker 8001.

The electronic device 8001 is, for example, a so-called “wearable device” of a watch type, which is removable freely from a human body. The electronic device 8001 is provided with, for example, a band section 8011 to be worn on an arm, a display device 8012 for displaying numerals, characters, patterns or the like, and a manipulation button 8013. The band section 8011 has, formed therein, a plurality of holes 8011a and a projection 8011b formed on an inner peripheral surface (i.e., a surface of the electronic device 8001 which is located on the side that comes in contact with the arm during the wearing of the electronic device 8001) side.

During the period when the electronic device 8001 is used, the electronic device 8001 is folded in such a manner that the band section 8011 can take an approximately round form as shown in FIG. 21, so that the projection 8011b is inserted into the hole 8011a. In this manner, the electronic device 8001 can be worn on an arm. The diameter of the electronic device 8001 can be adjusted in accordance with the size of the arm by controlling the position of the hole 8011a into which the projection 8011b is to be inserted. During the period when the electronic device 8001 is not used, the projection 8011b is removed from the hole 8011a, and the band section 8011 is stored in an approximately flat form. A sensor is provided, for example, in the whole area of the band section 8011.

In FIG. 22, a block diagram illustrating one example of the configuration of the electronic device 8001 is shown. As shown in FIG. 22, the electronic device 8001 is provided with a sensor 8020 including a controller IC 8015 that serves as a driving control unit and a host device 8016, in addition to the display device 8012. The electronic device 8001 may also be configured such that the sensor 8020 includes the controller IC 8015.

The sensor 8020 can detect both of a pressing force and bending. The sensor 8020 detects the change in electrostatic capacitance in accordance with the pressing force, and outputs an output signal corresponding to the change to the controller IC 8015. The sensor 8020 can also detect the change in a resistance value (change in resistance) in accordance with the degree of bending, and outputs an output signal corresponding to the change to the controller IC 8015.

The host device 8016 performs various kinds of processing on the basis of information supplied from the controller IC 8015. For example, the display of character information, image information or the like on the display device 8012, the movement of a cursor displayed on the display device 8012, the scrolling on a screen and the like can be performed.

The display device 8012 is, for example, a flexible display device, and displays a projected image (a picture image) on the basis of an image single, a control signal or the like supplied from a host device 8016. Examples of the display device 8012 include, but not limited to, a liquid crystal display device, an electroluminescence (EL) display, an electronic paper and the like.

The battery mentioned in Example 1 to Example 3 which serves as a power supply and an electronic circuit shown in FIG. 22 are enclosed in the band section 8011. The electronic device 8001 is provided with an electronic circuit that is the main body and a battery pack. The electronic device 8001 is so configured that the battery pack is removable by a user.

The present disclosure is described above with reference to preferred examples. However, the present disclosure is not limited to these examples. The configurations of the positive electrode member and the negative electrode member, the raw materials used in the production, the production methods, the conditions for the production, and the configurations and structures of the batteries and the secondary batteries which are mentioned in the examples are illustrative purpose only, and are not limited thereto and can be modified appropriately. The configuration or structure of the battery of the present disclosure can be applied to a primary battery.

Hereinbelow, Modification Examples 1 to 3 of the battery according to the present disclosure or the like will be described.

As shown in FIG. 23, the external packaging member 50 may be composed of a single laminate film. The external packaging member 50 has a rectangular shape, and is folded back along the center thereof in such a manner that sides can be superposed on each other, and the periphery of the external packaging member 50 is fusion-bonded. On the boundary of the folding, a cut line or the like may be provided in advance. Between the folded parts of external packaging member 50, a multilayer structure 11 and a multilayer member 12 are sandwiched. Even when a shorter-side periphery of the battery which is opposed to another shorter side of the battery, from which overhanging parts 23 and 33 are protruded, is fusion-bonded, the occurrence of cracking in the opposed shorter side of the external packaging member 50 can be prevented and the bending resistance of the battery against the above-mentioned curling can be improved even if the battery is curled so that the shorter side peripheries can have an arch-like form.

As shown in FIG. 24, the battery 10 may have a triangular form. The shape of the battery 10 is not particularly limited, and may be a polygonal form other than a triangular form and a rectangular form, a circular form, an elliptical form, an amorphous form or the like. The shape of the battery is not limited to a planar form, and may be an arch-like form, a spiral form, a tubular form or the like.

The direction of the protrusion of the overhanging part 23 and the overhanging part 33 is not particularly limited. The overhanging part 23 and the overhanging part 33 may protrude in different directions. For example, the overhanging part 23 and the overhanging part 33 may protrude from different shorter sides from each other or may protrude from different longer sides from each other, or one of the overhanging part 23 and the overhanging part 33 may protrude from a shorter side and the other may protrude from a longer side. Alternatively, both of the overhanging part 23 and the overhanging part 33 may protrude in the same direction from a single longer side.

After the battery is produced, the whole body of the battery may be heat-pressed. In this case, a portion of the polymeric compound contained in the electrolyte layer is diffused in the separator, the positive electrode mix layer and the negative electrode mix layer and, as a result, the separator, the positive electrode member and the negative electrode member can be integrated together. As a result, the bonding force between the positive electrode member and the negative electrode member can be improved.

As shown in FIG. 25A, the electrode body 120 may be configured so as to be provided with: two positive electrodes (first electrodes) 121A and 121B; a negative electrode (second electrode) 122 arranged between the two positive electrodes 121A and 121B: a separator 123A arranged between the positive electrode 121A and the negative electrode 122; and a separator 123B arranged between the positive electrode 121B and the negative electrode 122. The electrode body 120 may also be provided with: an electrolyte layer 24A arranged between the positive electrode 121A and the separator 123A; an electrolyte layer 24B arranged between the negative electrode 122 and the separator 123A; an electrolyte layer 24A arranged between the positive electrode 121B and the separator 123B; and an electrolyte layer 24B arranged between the negative electrode 122 and the separator 123B. In FIG. 25A, gap spaces are provided between the individual members for the purpose of enhancing the understanding of the configuration of the electrode body 20. Actually, however, the individual members are closely contacted with each other.

In the case where the electrode body 120 has the above-mentioned configuration, each of the positive electrodes 121A and 121B is provided with a positive electrode current collector (first current collector) 21A and a positive electrode active material layer (first active material layer) 21B arranged on one surface of the positive electrode current collector 21A. The negative electrode 122 is provided with a negative electrode current collector (second current collector) 22A and negative electrode active material layers (second active material layers) 22B respectively arranged on both surfaces of the negative electrode current collector 22A. The positive electrode 121A and the negative electrode 122 are arranged in such a manner that the positive electrode active material layer 21B and the negative electrode active material layer 22B can face each other with the separator 123A interposed therebetween, and the positive electrode 121B and the negative electrode 122 are arranged in such a manner that the positive electrode active material layer 21B and the negative electrode active material layer 22B can face each other with the separator 123B interposed therebetween.

In the case where the electrode body 120 has the above-mentioned configuration, as shown in FIG. 25B, positive electrode current collector exposed parts 21N and 21N respectively formed in the two positive electrodes 121A and 121B are arranged at a position at which the exposed parts 21N and 21N can face each other, and are respectively bonded to both surfaces of the positive electrode lead 11 by welding or the like. In FIG. 25B, the illustration of electrolyte layers 24A and 24B is omitted for simplifying the drawing.

Alternatively, the electrode body may be provided with two negative electrodes (first electrodes), a positive electrode (second electrode) arranged between the two negative electrodes, and a separator arranged between the positive electrode and the negative electrode. In the case where the electrode body has the above-mentioned configuration, each of the negative electrodes is provided with a negative electrode current collector (first current collector) and a negative electrode active material layer (first active material layer) arranged on one surface of the negative electrode current collector. The positive electrode is provided with a positive electrode current collector (second current collector) and positive electrode active material layers (second active material layers) respectively arranged on both surfaces of the positive electrode current collector.

The present technology is described below in further detail according to an embodiment.

### [A01]

A battery provided with a multilayer structure including a plurality of multilayer members and an external packaging member which covers the multilayer structure,

wherein:

each of the multilayer members includes
a positive electrode member provided with a positive electrode current collector and a positive electrode mix layer formed on one surface of the positive electrode current collector,
an electrolyte-containing separator, and
a negative electrode member provided with a negative electrode current collector and a negative electrode mix layer formed on one surface of the negative electrode current collector;

the positive electrode member, the separator and the negative electrode member are laminated together and are arranged in such a manner that the positive electrode mix layer and the negative electrode mix layer can face each other;

the multilayer members are stacked on each other in such a manner that the current collectors having the same polarity can face each other; and

the external packaging member is provided with at least a resin layer having a Young's modulus of 3×10⁹ Pa or more.

### [A02]

The battery according to [A01], wherein the electrolyte has a gel-like or solid form.

### [A03]

The battery according to [A01] or [A02], wherein the external packaging member includes a resin layer, an intermediate layer and a heat-sealable material layer which are laminated in this order as observed from the outside of the external packaging member.

### [A04]

The battery according to [A03], wherein the resin layer contains a polyester-based resin.

### [A05]

The battery according to [A04], wherein the resin layer contains a polyethylene terephthalate resin.

### [A06]

The battery according to any one of [A03] to [A05], wherein the intermediate layer contains aluminum, an aluminum alloy, stainless steel, copper, a copper alloy, nickel or a nickel alloy.

### [A07]

The battery according to any one of [A01] to [A06], wherein the multilayer members are connected in parallel with each other in the multilayer structure.

### [B01]

A battery provided with a multilayer member and an external packaging member which covers the multilayer member,

wherein:

the multilayer member includes
a positive electrode member provided with a positive electrode current collector and a positive electrode mix layer formed on one surface of the positive electrode current collector,
an electrolyte-containing separator, and
a negative electrode member provided with a negative electrode current collector and a negative electrode mix layer formed on one surface of the negative electrode current collector;

the positive electrode member, the separator and the negative electrode member are laminated together;

the electrolyte has a gel-like or solid form; and

the external packaging member is provided with at least a resin layer having a Young's modulus of 3×10⁹ Pa or more.

### [B02]

The battery according to [B01], wherein the external packaging member includes a resin layer, an intermediate layer and a heat-sealable material layer which are laminated in this order as observed from the outside of the external packaging member.

### [B03]

The battery according to [B02], wherein the resin layer contains a polyester-based resin.

### [B04]

The battery according to [B03], wherein the resin layer contains a polyethylene terephthalate resin.

### [B05]

The battery according to any one of [B02] to [B04], wherein the intermediate layer contains aluminum, an aluminum alloy, stainless steel, copper, a copper alloy, nickel or a nickel alloy.

### [B06]

The battery according to any one of [B01] to [B05], wherein the external packaging member covers a multilayer structure including a plurality of multilayer members, each of the multilayer members is provided with a positive electrode mix layer and a negative electrode mix layer which are arranged so as to face each other, and the multilayer members are stacked on each other in such a manner that the current collectors having the same polarity can face each other.

### [C01]

A battery provided with an electrode body having a laminated structure and an external packaging member which houses the electrode body therein,

wherein:

the external packaging member is provided with an aluminum-containing metal layer, a first resin layer arranged on a first surface of the metal layer, and a second resin layer arranged on a second surface of the metal layer;

the external packaging member houses the electrode body therein in such a manner that the first resin layer can be located on an outer side; and

the first resin layer contains at least one of polyethylene terephthalate and polyethylene naphthalate and has a thickness of more than 40 μm.

### [D01]

The battery according to any one of [A01] to [C01], wherein the external packaging member is provided with a resin layer, an intermediate layer and a heat-sealable material layer which are laminate in this order as observed from the outside, and an adhesive agent layer is provided between the resin layer and the intermediate layer.

### [D02]

The battery according to [D01], wherein the adhesive agent layer has an empty space formed therein as observed in the thickness direction.

### [D03]

The battery according to [D01] or [D02], wherein a second adhesive agent layer is provided between the intermediate layer and the heat-sealable material layer.

### [D04]

The battery according to [D03], wherein the second adhesive agent layer has an empty space formed therein as observed in the thickness direction.

### [D05]

The battery according to any one of [A01] to [D04], wherein the separator is provided with a base and a surface layer formed on the base, and the surface layer includes inorganic particles and a resin material.

### [D06]

The battery according to any one of [A01] to [D05], wherein the electrolyte contains inorganic particles.

### [D07]

The battery according to [C01], wherein the first resin layer has a thickness of 45 μm or more.

### [D08]

The battery according to [C01], wherein the first resin layer has a thickness of 50 μm or more.

### [D09]

The battery according to [C01],

wherein:

the electrode body is provided with a positive electrode, a negative electrode, a separator, a first electrolyte layer arranged between the positive electrode and the separator, and a second electrolyte layer arranged between the negative electrode and the separator; and each of the first electrolyte layer and the second electrolyte layer contains an electrolyte solution and a resin material which carries the electrolyte solution.

### [D10]

The battery according to [D09], each of the first electrolyte layer and the second electrolyte layer further contains microparticles.

### [D11]

The battery according to [C01],

wherein:

the electrode body is provided with:
a positive electrode which has a positive electrode current collector and a positive electrode active material layer arranged on one surface of the positive electrode current collector,
a negative electrode which has a negative electrode current collector and a negative electrode active material layer arranged on one surface of the negative electrode current collector, and
a separator which is arranged between the positive electrode and the negative electrode; and

the positive electrode active material layer and the negative electrode active material layer face each other with the separator interposed therebetween.

### [D12]

The battery according to [C01],

wherein:

the electrode body is provided with
two first electrodes each of which has a first current collector and a first active material layer arranged on one surface of the first current collector,
a second electrode which has a second current collector and second active material layers respectively arranged on both surfaces of the second current collector and is arranged between the two first electrodes, and
separators each of which is arranged between each of the first electrodes and the second electrode; and

each of the first active material layers faces the second active material layer with each of the separators interposed therebetween.

### [D13]

The battery according to [C01], wherein the electrode body has a positive electrode lead and a negative electrode lead, and the outer periphery of the external packaging member is fusion-bonded in such a manner that one end of each of the positive electrode lead and the negative electrode lead can be guided to the outside of the external packaging member.

### [D14]

The battery according to [C01], wherein the external packaging member is provided with a first external packaging member and a second external packaging member, the first external packaging member and the second external packaging member are stacked together so as to sandwich the electrode body therebetween, and the periphery of the first external packaging member is fusion-bonded to the periphery of the second external packaging member.

### [D15]

The battery according to [C01], wherein the external packaging member is folded back so as to sandwich the electrode body therebetween, the folded peripheries of the external packaging member are overlaid to each other, and the overlaid peripheries are fusion-bonded to each other.

### [D16]

The battery according to [D15], wherein the folded part in the external packaging member is also fusion-bonded.

### [D17]

The battery according to [D01], wherein the adhesive agent layer contains an acrylic adhesive material.

### [D18]

The battery according to any one of [A01] to [D17], wherein the battery has bendability.

### [D19]

The battery according to any one of [A01] to [D18], wherein the battery has a thickness of 1 mm or less.

### [D20]

The battery according to any one of [A01] to [D19], wherein the battery has a thickness of 0.5 mm or less.

### [E01]

An electronic device provided with a battery as recited in any one of [A01] to [D06].

### [E02]

A wearable device provided with a battery as recited in any one of [A01] to [D06].

### [E03]

An IC card provided with a battery as recited in any one of [A01] to [D06].

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery, comprising:
a multilayer structure including a plurality of multilayer members, and
an external packaging member configured to cover the multilayer structure,
wherein:
each of the multilayer members includes
a positive electrode member including a positive electrode current collector and a positive electrode mix layer provided on a surface of the positive electrode current collector,
a separator configured to contain an electrolyte, and
a negative electrode member including a negative electrode current collector and a negative electrode mix layer provided on a surface of the negative electrode current collector;
the positive electrode member, the separator and the negative electrode member are laminated together, and the positive electrode mix layer and the negative electrode mix layer face each other;
the multilayer members are stacked on each other in such a manner that current collectors having a same polarity face each other; and
the external packaging member includes at least a resin layer having a Young's modulus of 3×10⁹ Pa or more.

2. The battery according to claim 1, wherein the electrolyte has a gel-like or solid form.

3. The battery according to claim 1, wherein the external packaging member includes the resin layer, an intermediate layer and a heat-sealable material layer which are laminated in this order as observed from outside of the external packaging member.

4. The battery according to claim 3, wherein the resin layer includes a polyester-based resin.

5. The battery according to claim 4, wherein the resin layer includes a polyethylene terephthalate resin.

6. The battery according to claim 3, wherein the intermediate layer includes one or more of aluminum, an aluminum alloy, stainless steel, copper, a copper alloy, nickel and a nickel alloy.

7. The battery according to claim 1, wherein the multilayer members are connected in parallel with each other in the multilayer structure.

8. A battery, comprising:
a multilayer member, and
an external packaging member configured to cover the multilayer member,
wherein:
the multilayer member includes
a positive electrode member including a positive electrode current collector and a positive electrode mix layer provided on a surface of the positive electrode current collector,
a separator configured to contain an electrolyte, and
a negative electrode member including a negative electrode current collector and a negative electrode mix layer provided on a surface of the negative electrode current collector;
the positive electrode member, the separator and the negative electrode member are laminated together;
the electrolyte has a gel-like or solid form; and
the external packaging member includes at least a resin layer having a Young's modulus of 3×10⁹ Pa or more.

9. A battery, comprising:
an electrode body having a laminated structure, and
an external packaging member,
wherein:
the external packaging member includes a metal layer including aluminum, a first resin layer provided on a first surface of the metal layer, and a second resin layer provided on a second surface of the metal layer;
the external packaging member is configured to accommodate the electrode body in such a manner that the first resin layer is located on an outer side; and
the first resin layer includes at least one of polyethylene terephthalate and polyethylene naphthalate, and the first resin layer has a thickness of more than 40 μm.

10. The battery according to claim 8, wherein the external packaging member includes the resin layer, an intermediate layer and a heat-sealable material layer which are laminate in this order as observed from outside of the external packaging member, and an adhesive agent layer is provided between the resin layer and the intermediate layer.

11. The battery according to claim 10, wherein the adhesive agent layer has an empty space as observed in a thickness direction.

12. The battery according to claim 10, wherein a second adhesive agent layer is provided between the intermediate layer and the heat-sealable material layer.

13. The battery according to claim 8, wherein the separator includes a base and a surface layer provided on a surface of the base, and the surface layer includes inorganic particles and a resin material.

14. The battery according to claim 8, wherein the electrolyte includes inorganic particles.

15. The battery according to claim 9, wherein the first resin layer has a thickness of 45 μm or more, and wherein the battery has a thickness of 1 mm or less.

16. The battery according to claim 9, wherein the first resin layer has a thickness of 50 μm or more, and wherein the battery has a thickness of 1 mm or less.

17. The battery according to claim 1, wherein the battery has a thickness of 0.5 mm or less.

18. An electronic device comprising the battery according to claim 1.

19. A wearable device comprising the battery according to claim 1.

20. An IC card comprising the battery according to claim 1.
